(19) United States
(12) Patent Application Publication
(10) Pub. No.: US 2020/0059976 A1
(43) Pub. Date: Feb. 20, 2020

(54) IoT DEVICE CONNECTIVITY, DISCOVERY, AND NETWORKING

(71) Applicant: Nokia of America Corporation, Murray Hill, NJ (US)

(72) Inventors: Randeep Bhatia, Murray Hill, NJ (US); Bhawna Gupta, Murray Hill, NJ (US); Steven Benno, Murray Hill, NJ (US); Jairo Esteban, Holmdel, NJ (US)

(21) Appl. No.: 16/487,294

(22) PCT Filed: May 9, 2017
(86) PCT No.: PCT/US17/31810

§ 371 Date: Aug. 20, 2019

(51) Int. Cl. H04W 76/11; H04W 12/08; H04W 60/00; H04W 8/00; H04L 29/06

(52) U.S. Cl. CPC H04W 76/11; H04W 12/0808; H04W 88/16; H04W 8/005; H04L 69/22; H04W 60/00

(57) ABSTRACT

The present disclosure generally discloses improvements in computer performance for supporting various capabilities for enabling Internet-of-Things (IoT) devices to communicate via communication networks. The capabilities for enabling IoT devices to communicate via communication networks may include IoT device connectivity capabilities, IoT device discovery capabilities, IoT device networking capabilities, or the like.

### TECHNICAL FIELD

The present disclosure relates generally to communication networks and, more particularly but not exclusively, to supporting communications of Internet-of-Things (IoT) devices.

### BACKGROUND

Internet-of-Things (IoT) devices are becoming increasingly prevalent and tend to be diverse (e.g., including many types of devices which may serve many different purposes). This prevalence and diversity of the IoT devices may present certain challenges in supporting communications of the IoT devices.

### SUMMARY

The present disclosure generally discloses capabilities configured to support communications of Internet-of-Things (IoT) devices.

In at least some embodiments, an apparatus is configured to support communications of an IoT device. The apparatus includes a processor and a memory communicatively connected to the processor. The processor is configured to send, by the IoT-related device toward a wireless access device of a wireless network, a create flow request message requesting establishment of a flow leg of a flow session for the IoT-related device where the create flow request message includes a flow identifier selected by the IoT-related device for the flow leg of the flow session. The processor is configured to support, between the IoT-related device and the wireless access device, communication of an IoT data packet including a unique device identifier of the IoT-related device, the flow identifier, and IoT device data. In at least some embodiments, a non-transitory computer-readable storage medium stores instructions which, when executed by a computer, cause the computer to perform a corresponding method for supporting communications of an IoT-related device. In at least some embodiments, a corresponding method for supporting communications of an IoT-related device is provided.

In at least some embodiments, an apparatus is configured to support communications of an IoT device. The apparatus includes a processor and a memory communicatively connected to the processor. The processor is configured to receive, by an IoT gateway device from a first device via a first flow leg of a flow session, a first packet including a first header and a first payload, where the first header includes a layer-2 address of the first device and a first flow identifier of the first flow leg and where the first payload includes IoT device data. The processor is configured to send, by the IoT gateway device toward a second device via a second flow leg of the flow session, a second packet including a second header and a second payload, where the second header includes a layer-2 address of the second device and a second flow identifier of the second flow leg and where the second payload includes the IoT device data. In at least some embodiments, a non-transitory computer-readable storage medium stores instructions which, when executed by a computer, cause the computer to perform a corresponding method for supporting communications of an IoT-related device. In at least some embodiments, a corresponding method for supporting communications of an IoT-related device is provided.

In at least some embodiments, an apparatus is configured to support communications of an IoT device. The apparatus includes a processor and a memory communicatively connected to the processor. The processor is configured to receive, by a wireless access device of a wireless network from an IoT-related device, an attach request message requesting attachment of the IoT-related device to the wireless network, where the attach request message includes a globally unique identifier of the IoT-related device and a unique device identifier of the IoT-related device. The processor is configured to send, by the wireless access device toward a network controller of the wireless network based on a determination that the wireless access device does not have an entry for the IoT-related device, the attach request message. The processor is configured to receive, by the wireless access device from the network controller, a message including a layer-2 address assigned to the IoT-related device and a layer-2 address of an IoT gateway device assigned for the IoT-related device. In at least some embodiments, a non-transitory computer-readable storage medium stores instructions which, when executed by a computer, cause the computer to perform a corresponding method for supporting communications of an IoT-related device. In at least some embodiments, a corresponding method for supporting communications of an IoT-related device is provided.

In at least some embodiments, an apparatus is configured to support communications of an IoT device. The apparatus includes a processor and a memory communicatively connected to the processor. The processor is configured to receive, by a network switch associated with a wireless access device from a network controller, flow entry information including a set of rules and a set of actions, the set of rules configured to match on a layer-2 address assigned to the IoT-related device or a layer-2 address of an IoT gateway device assigned for the IoT-related device, the set of actions including an indication that packets matching the set of rules are to be forwarded from the network switch toward the IoT gateway device or from the network switch toward the wireless access device. The processor is configured to receive, by the network switch, an IoT data packet including a layer-2 address field including the layer-2 address assigned to the IoT-related device or the layer-2 address of the IoT gateway device. The processor is configured to forward the IoT data packet from the network switch toward the wireless access device or toward the IoT gateway device based on the flow entry information. In at least some embodiments, a non-transitory computer-readable storage medium stores instructions which, when executed by a computer, cause the computer to perform a corresponding method for supporting communications of an IoT-related device. In at least some embodiments, a corresponding method for supporting communications of an IoT-related device is provided.

### BRIEF DESCRIPTION OF THE DRAWINGS

The teachings herein can be readily understood by considering the following detailed description in conjunction with the accompanying drawings, in which:

FIG. 1 depicts an example communication system configured to support communications of IoT devices;

FIG. 2 depicts an example message flow, within the context of the communication system of FIG. 1, for supporting layer-2 device connectivity for an IoT device;

FIG. 3 depicts an example message flow, within the context of the communication system of FIG. 1, for supporting device authentication, authorization, registration, and discovery for an IoT device;

FIG. 4 depicts an example message flow, based on the communication system of FIG. 1, for an IoT device based on a one-to-one communication mode; FIG. 5 depicts an example message flow, based on the communication system of FIG. 1, for an IoT device based on a one-to-many communication mode;

FIG. 6 depicts an example message flow, based on the communication system of FIG. 1, for an IoT device based on a one-to-many communication mode;

FIG. 7 depicts an example of a portion of a communication system including an IoT hub configured to support communications of multiple IoT devices;

FIG. 8 depicts an example of a method for use by an IoT-related device in communicating via a wireless network;

FIG. 9 depicts an example of a method for use by a wireless access device of a wireless network in supporting communications of an IoT-related device;

FIG. 10 depicts an example of a method for use by a network switch associated with a wireless access device in supporting communications of an IoT-related device;

FIG. 11 depicts an example of a method for use by an IoT gateway device in supporting communications of an IoT-related device; and

FIG. 12 depicts a high-level block diagram of a computer suitable for use in performing various functions presented herein.

To facilitate understanding, identical reference numerals have been used, where possible, to designate identical elements that are common to the various figures.

### DETAILED DESCRIPTION

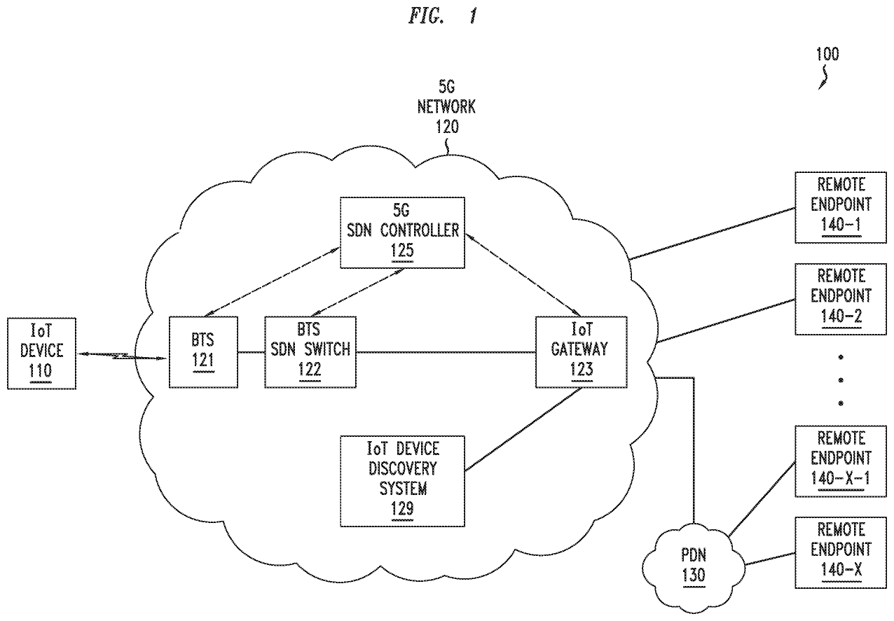

The present disclosure generally discloses a capability configured to support communications of Internet-of-Things (IoT) devices. The IoT device communication capability may be configured to support communications of IoT devices that may include Internet Protocol (IP) IoT devices and non-IP IoT devices. The IoT device communication capability may be configured to support communications of IoT devices over various types of communication networks, including wireline networks, wireless networks, or the like, as well as various combinations thereof. The IoT device communication capability may be configured to support various capabilities which may be used to support communications of IoT devices, such as IoT device connectivity capabilities, IoT device discovery capabilities, IoT device networking capabilities, or the like, as well as various combinations thereof. It will be appreciated that these and various other embodiments and potential advantages of the IoT device communication capability may be further understood by way of reference to the example communication system of FIG. 1.

FIG. 1 depicts an example communication system configured to support communications of IoT devices.

The communication system 100 is based on a Software Defined Networking (SDN) based implementation of a Fifth Generation (5G) network that is configured to support Internet-of-Things (IoT) devices and non-IoT devices.

The communication system 100 may be configured to support connectivity, discovery, and networking for IP-based and non-IP-based IoT devices over 5G networks. The communication system 100 may be configured to support connectivity, discovery, and networking for IP-based and non-IP-based IoT devices over 5G networks in a manner tending to address various challenges or potential challenges associated with support for IoT devices over 5G networks and other types of networks. In general, IoT devices typically need connectivity to the wide area network, as this enables seamless device discovery (e.g., discovery of sensors, actuators, or the like) and networking (e.g., for data exchange) in order to support IoT data acquisition (e.g., sensor data may be sent to the cloud for analysis, IoT-related devices may exchange information, or the like), IoT device control (e.g., remote control of sensors, remote control of actuators, or the like), or the like, as well as various combinations thereof. However, there are many challenges to supporting such functions for IoT devices. For example, in many types of IoT systems (e.g., cyber physical systems such as smart meters, smart grids, smart cities, and the like), there may be a need to send relatively small amounts of data intermittently between large numbers of low-end IoT devices; however, this may be problematic as traditional IP-based networking is not well-suited in cases where many of the IoT devices are non-IP devices, address allocation and management with such a large number of devices is challenging, and the infrequent transfers of relatively small packets can cause significant signaling and control plane overheads with IP-based protocols over mobile networks. Additionally, for example, discovery of authorized IoT devices and the device capabilities of authorized IoT devices, as well as connecting to such IoT devices and making use of the discovered capabilities of the IoT devices over a wide area network, may be difficult under certain conditions (e.g., where different IoT devices may natively use different networking protocols, at least some of which may have relatively limited reach (e.g., local area network (LAN), point-to-point, or the like) and may not directly provide wide area network connectivity. Additionally, for example, networking between IoT devices and various other types of devices may have various overheads associated therewith, which may impact efficiency, latency, or the like, as well as various combinations thereof.

The communication system 100 may be configured to support connectivity, discovery, and networking for IP-based and non-IP-based IoT devices over 5G networks.

The communication system 100 may be configured to support IoT network slices configured to support connectivity, discovery, and networking for IP-based and non-IP-based IoT devices over 5G networks.

The IoT network slices may be dedicated, cloud-based, SDN-powered 5G network slices deployed, possibly as an overlay, to serve IoT devices in an optimized manner.

The IoT network slices may be highly customized for IoT. For example, the control and bearer planes may be isolated from each other so that each can be independently provisioned and scaled, in terms of resources, as needed. For example, the control and data planes may be specifically designed for low-overhead transmission of IoT data. For example, for an IoT network slice supporting mostly stationary IoT devices, the mobility management control functions may be deployed on a limited scale or even eliminated.

The IoT network slices may be deployed in the cloud using virtualized control and bearer functions that can be dynamically configured to meet various performance goals for IoT. For example, a bearer-less control plane may be deployed to efficiently support connectivity for non-IP devices, thereby obviating the need for per-device IP addresses (and, thus, removing the need for associated IP address assignment and management) and PDN connections (and, thus, reducing the signaling and bearer resources and overheads (including latency) for PDN connections.

The IoT network slices may be configured to support improved data networking and transmissions for IoT devices.

For example, the IoT network slices may be configured to separate and isolate devices in order to enforce access control (e.g., only devices in the same slice can communicate with each other).

For example, the IoT network slices may be configured to support use of name-based or identifier-based addressing for IoT devices in the 5G network. For example, globally unique names or identifiers of IoT devices (e.g., mobile device identifiers (e.g., International Mobile Equipment Identifiers (IMEIs)), mobile subscriber identifiers (e.g., International Mobile Subscriber Identities (IMSIs), Temporary Mobile Subscriber Identities (TMSIs), or the like), layer-2 addresses, serial numbers, public keys, or the like, as well as various combinations thereof) may be used as addresses for the IoT devices (e.g., in place of IP addresses). This may enable support for data networking and transmission for non-IP-based IoT devices and may also be useful for IP-based IoT devices.

For example, the IoT network slices may be configured to support initiation of data transmission for IoT devices, after successful attachment of the IoT devices to the 5G network (e.g., authentication, authorization and registration), even though IP addresses have not been assigned for the IoT devices (e.g., based on use of unique device identifiers for the IoT devices, rather than use of IP addresses for the IoT devices, as discussed above).

For example, the IoT network slices may be configured to support a minimal routing and transport header between IoT devices and IoT gateways, with forwarding being handled based on layer-2 headers (e.g., Media Access Control (MAC) headers such as Ethernet MAC, 5G MAC, or the like). This may be particularly useful for transport of relatively small packets (for which there may be substantial header overhead when IP-based networking is used), thereby enabling efficient infrequent small packet data transfers over 5G networks.

For example, the IoT network slices may be configured to support IP-based connectivity by IP-based and non-IP-based IoT devices. This may enable IP-based connectivity to remote endpoints for connecting with external services (e.g., IoT data collectors, non-IoT servers or devices, or the like, as well as various combinations thereof). This may include protocol translations which may be performed by the 5G network on behalf of various devices, such that various combinations of IoT and non-IoT protocols and applications may be supported between various combinations of IP-based and non-IP-based devices (e.g., Constrained Application Protocol (COAP), Message Queue Telemetry Transport (MQTT), Hypertext Transfer Protocol (HTTP), Representational State Transfer (REST), or the like).

The IoT network slices may be configured to provide various other functions configured to support improved data networking and transmissions for IoT devices.

The communication system 100 may be configured to support various functions, within the context of IoT network slices or otherwise, to support connectivity, discovery, and networking for IP-based and non-IP-based IoT devices over 5G networks.

The communication system 100 includes an IoT device 110, a 5G network 120, a packet data network (PDN) 130, and a set of remote endpoints (REs) 140-1-140-X (collectively, REs 140).

The IoT device 110 may be any IoT device configured to access and communicate over the 5G network. For example, the IoT device 110 may be a sensor (e.g., temperature sensor, humidity sensor, motion sensor, or the like), an actuator (e.g., for controlling home devices, for controlling devices in manufacturing, or the like). The IoT device 110 may provide IoT functions within various IoT contexts and applications, such as for home or business control applications, location applications, weather monitoring applications, smart grid applications, smart city applications, or the like, as well as various combinations thereof. The IoT device 110 may be a non-IP device (e.g., without a layer 3 or layer 4 stack) or an IP device (e.g., having a layer 3 or layer 4 stack), although various embodiments presented herein are primarily presented within the context of a non-IP IoT device. The IoT device 110 may be configured to support one or more IoT application layer protocols, such as Zigbee, Profinet, or the like, as well as various combinations thereof. The IoT device 110 may be various other types of IoT devices configured to provide various other IoT or IoT related functions.

The IoT device 110 has certain identifiers associated therewith, which may be used for various control and data communication purposes.

The IoT device 110 has a globally unique identifier (GUID) associated therewith. The GUID of the IoT device 110 is agnostic of the underlying type of communications technology (e.g., 5G network 120 versus WiFi or other underlying communications technologies). For example, GUID of the IoT device 110 may be a layer-2 address of the IoT device 110, a public key of the IoT device 110, an identifier assigned by the 5G network 120 for the IoT device 110, or the like. The GUID of the IoT device 110 may be included in certain control messages sent by the IoT device 110, as discussed further below.

The IoT device 110 has a unique device identifier associated therewith. The unique device identifier of the IoT device is specific to the underlying technology and may be different for different technology types (e.g., 5G network 120 versus WiFi or other underlying communications technologies). For example, the unique device identifier of the IoT device 110 may be a layer-2 address of the IoT device 110 (e.g., if it is an Ethernet device), an identifier assigned by the 5G network 120 for the IoT device 110 (e.g., if it is a 5G device), or the like. The unique device identifier of the IoT device 110 is included in control messages and data messages sent by the IoT device 110 (e.g., included by the access technology protocols (e.g., within the physical or MAC layers)), as discussed further below.

The 5G network 120 includes a Base Transceiver Station (BTS) 121, a BTS SDN switch 122, an IoT gateway 123, and an SDN controller 125.

The BTS 121, the BTS SDN switch 122, and the IoT gateway 123 form part of the data plane of the 5G network 120. The BTS 121 is configured to operate as a wireless point of access to the 5G network 120 for the IoT device 110 (as well as other devices, which have been omitted for purposes of clarity). The BTS SDN switch 122 is configured to operate as a forwarding element for the BTS 121, under the controller of the 5G SDN controller 125, for supporting forwarding of traffic from BTS 121 (e.g., uplink traffic from the IoT device 110) and forwarding of traffic to BTS 121 (e.g., for downlink traffic to the IoT device 110). The IoT gateway 123 is configured to perform various IoT-related control functions for the IoT device 110, including support for IoT device connectivity, discovery, networking, or the like, as well as various combinations thereof.

The 5G SDN controller 125 is part of the control plane of the 5G network 120. The 5G SDN controller 125 is configured to operate as a control element for controlling the BTS SDN switch 122 (as well as other SDN forwarding elements, which have been omitted for purposes of clarity), the IoT gateway 123, or the like, as well as various combinations thereof. The 5G SDN controller 125 may be configured to steer IoT device traffic associated with the IoT device 110 (e.g., IoT device data that is provided by the IoT device 110, IoT device commands that are intended for the IoT device 110, or the like, as well as various combinations thereof) by dynamically programming the data plane (namely, the BTS SDN switch 122, the IoT gateway 123, and any other elements or devices which may need to be programmed). The 5G network 120, a discussed further below, may provide directed connectivity for one or more of the REs 140 (e.g., via the IoT gateway 123 or other suitable devices of the 5G network 120).

The PDN 130 may include any suitable type(s) of packet data network(s) which may be accessible via the 5G network 120. For example, the PDN may be a public PDN (e.g., the Internet), a private PDN (e.g., an enterprise network, a cloud network, or the like), or the like, as well as various combinations thereof. The PDN 130 may interface with the 5G network via the IoT gateway 123, one or more other elements of the 5G network (e.g., a PDN gateway (PGW) or other suitable type of element), or the like, as well as various combinations thereof. The PDN 130 may be configured to support communications via the 5G network 120 based on various types of underlying communications technologies. The PDN 130, as discussed further below, may provide connectivity for one or more of the REs 140.

The REs 140 include devices configured to interact with the IoT device 110. The REs 140, as indicated above, may include endpoints directly connected to the 5G network 120 (e.g., other IoT devices which may be connected to the IoT gateway 123 or which may be connected to other IoT gateways of the 5G network 120, IoT servers, non-IoT servers or devices, or the like), endpoints accessible via the PDN 130 (e.g., other IoT devices, IoT servers, non-IoT servers or devices, or the like), or the like, as well as various combinations thereof. The REs 140 may include IoT devices, IoT servers, IoT device data consumers, non-IoT servers and devices, or the like, as well as various combinations thereof. The REs 140 may include devices supporting IP, devices that do not support IP, or combinations thereof. The REs 140 may have unique device identifiers associated therewith (primarily referred to herein as a globally unique identifier (GUIDs) for the REs 140), which may be layer-2 addresses, a public keys, identifiers assigned by the 5G network 120, or the like. The REs 140 may include various other devices configured to interact with the IoT device 110.

It will be appreciated that the communication system 100, although primarily presented as including specific types, numbers, and arrangements of elements that support IoT device connectivity, discovery, and networking functions, may include various other types, numbers, or arrangements of elements configured to support IoT device connectivity, discovery, and networking functions.

The communication network 100 may be configured to support layer-2 connectivity establishment by the IoT device 110 with the 5G network 120.

The IoT device 110 is authenticated and authorized by the 5G network 120 before the IoT device 110 sends any data. In order for the IoT device 110 to be authenticated and authorized by the 5G network 120, layer-2 connectivity is established between the IoT device 110 and the 5G network 120 and then authentication and authorization messages may be exchanged between the IoT device 110 and the 5G network 120 in order for the IoT device 110 to be authenticated and authorized by the 5G network 120.

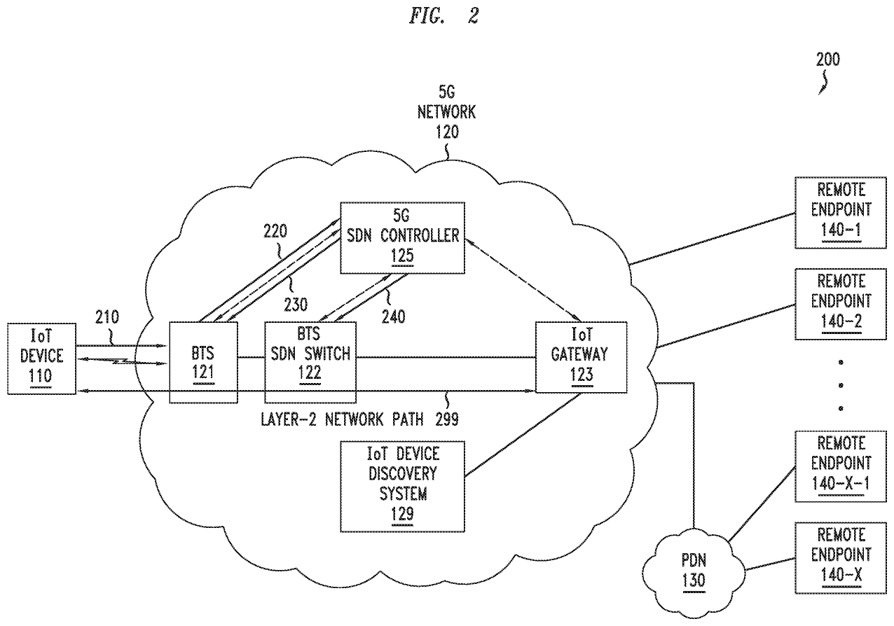

FIG. 2 depicts an example message flow, within the context of the communication system of FIG. 1, for supporting layer-2 device connectivity for an IoT device.

At step 210, the IoT device 110 attaches to the 5G network by sending a 5G network attach message that is received by the BTS 121. The 5G network attach message includes the GUID of the IoT device 110 and the unique device identifier of the IoT device 110. The IoT device 110 is not currently registered with the 5G SDN controller 125 at this point and, as such, there is no mapping at the BTS 121 for the IoT device 110 when the 5G network attach message is received. The BTS 121 may determine that the IoT device 110 is not registered with the 5G SDN controller 125 based on a determination by the BTS 121 that the BTS 121 does not have an entry associated with the GUID of the IoT device 110 as determined by the BTS 121 from the 5G network attach message that has been received.

At step 220, the BTS 121, based on a determination that the IoT device 110 is not registered with the 5G SDN controller 125, sends the 5G network attach message to the 5G SDN controller 125.

The 5G SDN controller 125 determines that the 5G IoT device 110 is not registered with the 5G network 120. The 5G SDN controller 125 may determine that the IoT device 110 is not registered with 5G network 120 based on a determination by the 5G SDN controller 125 that the 5G SDN controller 125 does not have an entry associated with the GUID of the IoT device 110 that is determined by the 5G SDN controller 125 from the 5G network attach message received from the BTS 121.

The 5G SDN controller 125, based on a determination that the IoT device 110 is not registered with the 5G network 120, may identify the 5G network attach message as being a network attach message (as opposed to a different type of message) and determine whether the IoT device 110 is permitted to access the 5G network 120. The determination as to whether the IoT device 110 is permitted to access the 5G network 120 may be based on one or more policies (e.g., whitelisting, blacklisting, or the like). It is noted that the one or more policies may include one or more policies of one or more of the network operator, the device owner, the device service provider, or the like.

The 5G SDN controller 125, based on a determination that the IoT device 110 is permitted to access the 5G network 120, selects a 5G mobile gateway for the IoT device 110 (namely, the IoT gateway 123 which, although omitted for purposes of clarity, it will be appreciated may be one of multiple IoT gateways available within the 5G network 120) and allocates a layer-2 address (e.g., MAC address) to the IoT device 110. The selection of the IoT gateway 123 for the IoT device 110 may be based on a load balancing scheme or other suitable gateway selection mechanism. The layer-2 address that is allocated to the IoT device 110 may be in the namespace of the IoT gateway 123 selected for the IoT device 110. The 5G SDN controller 125 also determines the layer-2 address (e.g., MAC address) of the IoT gateway 123 selected for the IoT device 110). The 5G SDN controller 125 may maintain mapping information for the IoT device 110 (e.g., mappings between the GUID of the IoT device 110, the unique device identifier of the IoT device 110, the layer-2 address for the IoT device 110, an indication of the IoT gateway 123 selected for the IoT device 110, the layer-2 address of the IoT gateway 123 selected for the IoT device 110, or the like, as well as various combinations thereof).

At step 230, the 5G SDN controller 125 responds to the BTS 121, responsive to the 5G network attach message of the IoT device 110, by providing to the BTS 121 the layer-2 address for the IoT device 110 and the layer-2 address of the IoT gateway 123 selected for the IoT device 110.

The BTS 121 receives the layer-2 address for the IoT device 110 from the 5G SDN controller 125.

The BTS 121 creates local mapping information for the IoT device 110. The local mapping information for the IoT device 110 may include mappings between the GUID of the IoT device 110, the unique device identifier of the IoT device 110, the layer-2 address for the IoT device 110, an indication of the IoT gateway 123 selected for the IoT device 110, the layer-2 address of the IoT gateway 123 selected for the IoT device 110, or the like, as well as various combinations thereof).

The BTS 121 may then process the packet that included the 5G network attach message of the IoT device 110. The BTS 121 may process the packet that included the 5G network attach message of the IoT device 110 by creating a new layer-2 packet (e.g., Ethernet packet) based on the received packet (e.g., by copying the received packet into the new layer-2 packet) and setting a source layer-2 address of the new layer-2 packet to the layer-2 address for the IoT device 110 (e.g., the MAC address of the IoT device 110 received by the BTS 121 from the 5G SDN controller 125) and setting a destination layer-2 address of the new layer-2 packet to the layer-2 address of the IoT gateway 123 assigned to the IoT device 110 (e.g., the layer-2 address of the IoT gateway 123 received by the BTS 121 from the 5G SDN controller 125). The BTS 121 then provides the new layer-2 packet to the BTS SDN switch 122. It will be appreciated that, alternatively, the packet that included the 5G network attach message of the IoT device 110 may not be further propagated (e.g., where the packet does not include any payload data to be further communicated but, rather, was merely for the purpose of supporting the network attachment of the IoT device 110), and only subsequent packets that are received from the IoT device 110 are further propagated by the BTS 121 toward the IoT gateway 123.

It will be appreciated that, although primarily discussed with respect to use of the local mapping information by the BTS 121 to support communications from the IoT device 110 toward the 5G network 120, the local mapping information also may be used by the BTS 121 to support downstream communications from the 5G network 120 to the IoT device 110.

At step 240, the 5G SDN controller 125 sets flow information (e.g., one or more flow entries) in the BTS SDN switch 122 for the IoT device 110. The flow information is configured to support communication of packets that include the layer-2 address that has been allocated to the IoT device 110 and the layer-2 address of the IoT gateway 123 selected for the IoT device 110, thereby enabling support for communications of the IoT device 110 between the BTS SDN switch 122 and the IoT gateway 123 selected for the IoT device 110.

The BTS SDN switch 122 receives the flow information for the IoT device 110 from the 5G SDN controller 125 and maintains the flow information for the IoT device 110 (e.g., creates a flow entry for the IoT device 110). The flow entry may include a set of rules to be matched and one or more associated actions to be performed when layer-2 packets matching the flow entry are received. For example, the flow entry may be configured to support matching on the Ethernet header fields of the Ethernet packet (e.g., where the source MAC address field includes the MAC address of the IoT device 110 and the destination MAC address field includes the MAC address of the IoT gateway 123) with an associated action of forwarding the Ethernet packet to the IoT gateway 123 selected for the IoT device (e.g., over a persistent tunnel that exists between the BTS SDN switch 122 and the IoT gateway 123 or using any other suitable tunnel or connection). The BTS SDN switch 122 may then process the new layer-2 packet received from the BTS 121 (assuming, as discussed above, that the BTS 121 will forward the initial packet received from the IoT device 110). The BTS SDN switch 122 may process the new layer-2 packet by matching on the flow entry created for the IoT device 110 and forwarding the packet toward the IoT gateway 123 based on the action indicated in the flow entry created for the IoT device 110. It will be appreciated that, alternatively, the packet that included the 5G network attach message of the IoT device 110 may not be further propagated by the BTS 121 to the BTS SDN switch 122 (and, thus, that the BTS SDN switch 122 may not need to further handle such a new layer-2 packet).

It will be appreciated that, although primarily discussed with respect to the use of the flow information to support upstream communications from the IoT device 110 toward the 5G network 120, the 5G SDN controller 125 may set and the BTS SDN switch 122 may support flow information which may be used to support downstream communications to the IoT device (e.g., flow information such as a downstream flow entry configured to support downstream communications from the 5G network 120 to the IoT device 110). The downstream flow entry may include a set of rules to be matched and one or more associated actions to be performed when Ethernet packets matching the flow entry are received. For example, the downstream flow entry may be configured to support matching on the Ethernet header fields of the Ethernet packet (e.g., where the source MAC address field includes the MAC address of the IoT gateway 123 and the destination MAC address field includes the MAC address of the IoT device 110) with an associated action of forwarding the Ethernet packet toward the BTS 121 for delivery to the IoT device 110 over the air.

The layer-2 connectivity establishment process discussed above results in a layer-2 network path (both uplink and downlink) between the IoT device 110 and the IoT gateway 123 (illustratively, layer-2 network path 299), which may then be used to support communication of IoT-related data for the IoT device 110 (e.g., upstream communication of IoT device data originating at the IoT device 110, downstream communication of IoT-related information intended for delivery to the IoT device 110 (e.g., requests, instructions, or the like), or the like, as well as various combinations thereof). The communication of IoT-related data for the IoT device 110 may be similar to that discussed above for handling of the packet that included the 5G network attach message.

The communication of IoT-related data for the IoT device 110 in the upstream direction (e.g., IoT device data reported by the IoT device 110, responses by the IoT device 110 to messages (e.g., instructions, commands, or the like) received from remote devices, or the like) may be performed as follows. The IoT device 110 sends a packet to the BTS 121. The packet includes the unique device identifier of the IoT device 110 and IoT-related data being communicated by the IoT device 110. The BTS 121 receives the packet and determines, based on a mapping available to the BTS 121 for the IoT device 110, that the IoT device 110 from which the packet is received has been assigned a layer-2 address (e.g., MAC address) and a serving IoT gateway. The BTS 121 encapsulates the payload of the received packet into a layer-2 packet (e.g., Ethernet packet) with the source and destination layer-2 addresses (e.g., MAC addresses) set to the layer-2 address of the IoT device 110 and the layer-2 address of the IoT gateway 123, respectively, to generate thereby a new packet. The BTS 121 provides this new packet to the BTS SDN switch 122. The BTS SDN switch 122 receives the new packet, determines that the layer-2 header fields of the new packet (e.g., source and destination MAC addresses, and possibly others) match a flow entry with a corresponding action that indicates that the new packet is to be forwarded to the IoT gateway 123, and forwards the new packet to the IoT gateway 123 (from which point the packet may then be further routed to its intended destination).

The communication of IoT-related data for the IoT device 110 in the downstream direction (e.g., requests for data from the IoT device 110, instructions for execution by the IoT device 110, or the like) may be performed as follows. The IoT gateway 123 receives a layer-2 packet (e.g., Ethernet packet) that is intended for delivery to the IoT device 110. The IoT gateway 123 determines that the layer-2 header fields of the layer-2 packet (e.g., source and destination layer-2 addresses, and possibly others) match a flow entry with a corresponding action that indicates that the layer-2 packet is to be forwarded to the BTS SDN switch 122. The IoT gateway 123 modifies the layer-2 packet, by setting the source and destination layer-2 addresses to the layer-2 address of the IoT gateway 123 and the layer-2 address of the IoT device 110, respectively, to form a modified layer-2 packet. The IoT gateway 123 forwards the modified layer-2 packet to the BTS SDN switch 122. The BTS SDN switch 122 provides the modified layer-2 packet to the BTS 121. The BTS 121 performs a look-up based on the layer-2 address of the IoT device 110 that is specified in the destination layer-2 address of the modified layer-2 packet to identify the IoT device 110 as the intended destination of the modified layer-2 packet, extracts the IoT-related data intended for delivery to the IoT device 110 from the payload of the modified layer-2 packet, and sends the IoT-related data intended for delivery to the IoT device 110 to the IoT device 110 over the air interface. The BTS 121 may send the IoT-related data intended for delivery to the IoT device 110 to the IoT device 110 using a packet that includes the unique device identifier of the IoT device 110 (which may be determined by the BTS 121 based on a mapping available to the BTS 121 for the IoT device 110) and the IoT-related data intended for delivery to the IoT device 110.

It will be appreciated that, in at least some embodiment, forwarding of IoT-related data of the IoT device 110 between the BTS SDN switch 122 and the IoT gateway 123 may be performed using a persistent tunnel. The persistent tunnel may be proactively provisioned in advance. The persistent tunnel may be connectionless. The persistent tunnel may be shared among multiple IoT devices associated with the BTS 121 that are assigned to that IoT gateway 123 (e.g., all of the IoT devices or some of the IoT devices if only a subset of the IoT devices can be supported by the persistent tunnel). It is noted that sharing of the persistent tunnel in this manner obviates the need for per-device packet data network (PDN) connections for the IoT devices sharing the persistent tunnel, thereby eliminating overheads in both the control and bearer planes. It will be appreciated that other types of tunnels or connections may be used to transport IoT-related data of the IoT device 110 between the BTS SDN switch 122 and the IoT gateway 123.

The layer-2 connectivity establishment process discussed above results in a layer-2 network path (both uplink and downlink) between the IoT device 110 and the IoT gateway 123 (illustratively, layer-2 network path 299), which may then be used to support authentication and authorization of the IoT device 110 with the 5G network 120 and registration of the IoT device 110 with the 5G network 120. The authentication, authorization, and registration of the IoT device 110 with the 5G network 120 may be performed by the IoT gateway 123 on behalf of the 5G network 120 (since the layer-2 network path 299 from the IoT device 110 to the IoT gateway 123 has already been established). The authentication and authorization of the IoT device 110 ensures that the IoT device 110 is the device that it is claiming to be. The authentication and authorization of the IoT device 110 may be performed by the IoT gateway 123 based on the initial packet received from the IoT device 110 as discussed above (e.g., verifying a digital signature (e.g., using PKI) of the IoT device 110 that the IoT device 110 includes in the initial packet), based on a separate interaction between the IoT device 110 and the IoT gateway 123 (e.g., in which the IoT device 110 provides a digital signature for verification by the IoT gateway 123, using a challenge-response interaction in which the IoT gateway 123 sends a challenge to the IoT device 110 and the IoT device 110 responds with a response that is verified by the IoT gateway, or the like), or the like.

If the IoT device is successfully authorized and authenticated, the IoT device 110 and the IoT gateway 123 may set up a shared security key (e.g., by using a Diffie-Hellman key exchange) based on a determination that additional security is needed for communication over-the-air. The shared security key, in addition to being known by the IoT device 110 and the IoT gateway 123, may be provided to the 5G SDN controller 125, which may maintain the security key for the IoT device 110 (in addition to the layer-2 address that it assigns to the IoT device 110 and an indication of the IoT gateway 123 assigned to the IoT device 110 by the 5G SDN controller 125).

If the IoT device 110 is successfully authorized and authenticated, the IoT device 110 may register with the 5G network 120. The IoT device 110 may register with the 5G network 120 by registering information about itself with the 5G network 120. The information that is registered may include various types of capability information and accessibility information (e.g., type(s) of data available from the IoT device 110, frequency of data updates at the IoT device 110, indications of which entities are permitted to access which data of the IoT device 110, or the like, as well as various combinations thereof). In at least some embodiments, the 5G network 120 may obtain at least part of the information from a source other than the IoT device 110, such as from a device database (e.g., with the lookup being performed based on the GUID of the IoT device 110), a third-party entity, or the like, as well as various combinations thereof. The registration of the IoT device 110 enables device discovery to be supported, as discussed further below.

The 5G network 120 is configured to support IoT device discovery capabilities for the IoT device 110 (as well as other IoT devices registered with the 5G network 120). Namely, after the IoT device 110 has been authenticated and authorized by the 5G network 120 and has registered with the 5G network 120, the 5G network 120 may support discovery of the IoT device 110.

The 5G network 120 may support discovery of the IoT device 110 (as well as other IoT devices registered with the 5G network 120) by various devices or entities. For example, the IoT device 110 may be discovered by IoT data collectors, third-party entities which may be interested in IoT data of the IoT device 110, or the like, as well as various combinations thereof. For example, the IoT device may be discovered by one or more of the REs 140.

The 5G network 120 may support discovery of the IoT device 110 by exposing searchable IoT device discovery information associated with the IoT device 110 (e.g., static and/or dynamic metadata or other suitable types of information which may be useful in discovering the IoT device 110 and learning information about the IoT device 110). For example, such searchable IoT device discovery information which may be exposed to enable the IoT device 110 to be discovered may include the GUID of the IoT device 110, location information associated with the IoT device 110 (e.g., current location), ownership information indicative of the entity that owns or operates the IoT device 110, device capability information indicative of one or more capabilities of the IoT device 110, or the like, as well as various combinations thereof. It will be appreciated that the IoT device discovery information of the various IoT devices registered with the 5G network 120 may be searched in various ways to achieve various goals. For example, the 5G network 120 may advertise the ability of a sensor to serve both temperature and humidity data, and an authorized data collector may request (via a request to the 5G network 120) access to either or both of the temperature data stream or the humidity data stream of the sensor. For example, multiple data consumers may request access to all IoT devices that produce humidity data in a location or all devices registered to a particular user.

In at least some embodiments, the IoT device 110 or the entity that owns or operates the IoT device 110 (as well as other IoT devices registered with the 5G network 120 or the associated owners or operators of those IoT devices) can specify access control information configured for use by the 5G network 120 to control visibility of and access to information about the IoT device 110 (e.g., the IoT device information that may be exposed for use in searching for the IoT device 110, the IoT data of the IoT device 110 that is permitted to be accessed after the IoT device 110 has been discovered, or the like, as well as various combinations thereof), thereby providing a mechanism for specifying various types of permissions at various levels of granularity.

In at least some embodiments, in addition to registration of IoT devices, the 5G network 120 also may support registration of other IoT-related devices and entities which may be interested in the IoT devices registered with the 5G network 120 (e.g., authorized data collectors may register with the 5G network 120 to take advantage of data streams available from IoT devices registered with the 5G network 120, authorized services may registered with the 5G network 120 to take advantage of the device capabilities of IoT device registered with the 5G network 120, or the like, as well as various combinations thereof). For example, the 5G network 120 also may support registration of one or more of the REs 140.

These IoT device discovery capabilities supported by the 5G network 120 may be supported by one or more devices of the 5G network 120, such as IoT device discovery system 129 that is depicted in FIG. 1 (although it will be appreciated that such IoT device discovery capabilities may be provided by other existing or new elements of the 5G network 120, may be distributed across existing or new elements of the 5G network 120, or the like, as well as various combinations thereof).

The 5G network 120 may be configured to support various other IoT device discovery capabilities for IoT devices registered with the 5G network 120.

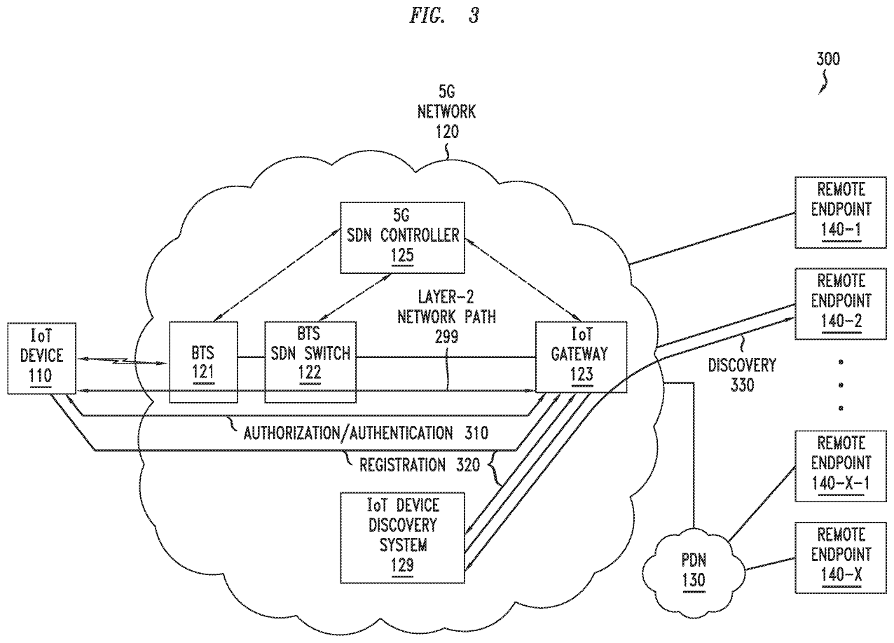

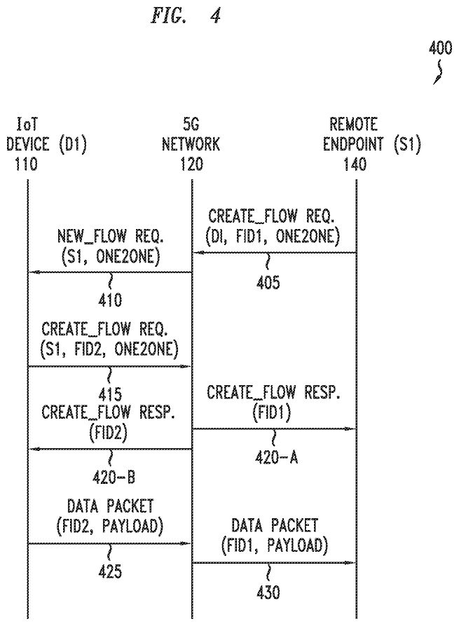

FIG. 3 depicts an example message flow, within the context of the communication system of FIG. 1, for supporting device authentication, authorization, registration, and discovery for an IoT device. At step 310, the IoT device 110 and the IoT gateway 123 communicate via the layer-2 network path 299 for enabling authorization and authentication of the IoT device 110 by the 5G network 120. At step 320, the IoT device 110 and the IoT gateway 123 communicate via the layer-2 network path 299 for enabling registration of the IoT device 110 by the 5G network 120 (where, as indicated in FIG. 3, registration of the IoT device 110, including registration of the device capabilities of the IoT device 110, with the 5G network 120 may be supported by the IoT device discovery system 129 based on communication between the IoT device 110 and the IoT device discovery system 129 via the layer-2 network path 299 and a connection between the IoT gateway 123 and the IoT device discovery system 129). At step 330, the 5G network 120 supports discovery of the IoT device 110 (including the associated device capabilities of the IoT device 110) by the RE 140-2 based on communication between the RE 140-2 and the 5G network 120 (where, as indicated in FIG. 3, discovery of the IoT device 110, including the device capabilities of the IoT device 110, by the RE 140-2 may be supported by the IoT device discovery system 129 based on communication between the RE 140-2 and the IoT device discovery system 129 via the IoT gateway 123 and a connection between the IoT gateway 123 and the IoT device discovery system 129). It will be appreciated that, although omitted for purposes of clarity, various other device authentication, authorization, and registration functions may be performed by the IoT device 110 and the 5G network 120, various other device discovery functions may be performed by REs 140 and the 5G network 120, or the like, as well as various combinations thereof.

The 5G network 120 may be configured to support various other capabilities for supporting device authentication, authorization, registration, and discovery of IoT devices with the 5G network 120.

The 5G network 120 may be configured to support various networking capabilities configured to support flow-based communications for the IoT device 110, including support for sending data streams from the IoT device 110 and support for receiving data streams at the IoT device 110.

The flow-based communications of the IoT device 110 may be between the IoT device 110 and one or more remote endpoints (e.g., REs 140), which may include devices, programs, or the like. The one more remote endpoints may include one or more entities with which the IoT device 110 may communicate via the 5G network 120 (e.g., entities disposed within the 5G network, entities accessible via the 5G network 120, or the like, as well as various combinations thereof). The one more remote endpoints may include end devices such as end user devices of end users which may communicate with the IoT device 110 (e.g., for receiving IoT device data from the IoT device, controlling the IoT device 110, or the like), network devices such as network-based IoT devices associated with the IoT device 110 (e.g., an IoT server associated with the IoT device 110, an IoT controller configured to control the IoT device 110, or the like), or the like, as well as various combinations thereof. The remote endpoints may operate in various roles associated with communications with the IoT device 110, such as operating as a controller, a consumer, or the like, as well as various combinations thereof.

The flow-based communications of the IoT device 110 traverses the 5G network 120, which may be configured to support flow-based communications of the IoT device 110 under various conditions related to device types, communication modes being used, communication layers/protocols supported, remote endpoint locations, or the like, as well as various combinations thereof. The forwarding of the flow-based communications of the IoT device 110 may be between the IoT device 110 and one or more remote endpoints which may be located at various network locations (e.g., located within or attached to the 5G network, accessible via other communication networks connected to the 5G network (e.g., wireline networks, other types of cellular networks, or the like), or the like, as well as various combinations thereof. The forwarding of the flow-based communications of the IoT device 110 is expected to be over a layer-2 network, such that the IoT device 110 may be an IP device (e.g., having a layer 3 or layer 4 stack) or a non-IP device (e.g., without a layer 3 or layer 4 stack). The forwarding of the flow-based communications of the IoT device 110 via the 5G network 120 (e.g., via the IoT gateway 123 or other suitable device of 5G network 120) may enable the IoT device 110 to communicate with one or more remote endpoints using Transmission Control Protocol (TCP) or User Datagram Protocol (UDP) over IP even where the IoT device 110 is a non-IP device that does not support TCP/IP or UDP/IP (e.g., communication between the IoT device 110 and the IoT gateway 123 uses layer-2 networking and communication between the IoT gateway 123 and the remote endpoint(s) uses TCP/IP or UDP/IP). The IoT device 110 and the one or more remote endpoints may support different application layer IoT protocols.

The flow-based communications between the IoT device 110 and the one or more remote endpoints may utilize various communication modes, including one or more of a one-to-one (O2O) communication mode, a one-to-many (O2M) communication mode, a many-to-one (M2O) communication mode, or a many-to-many (M2M) communication mode.

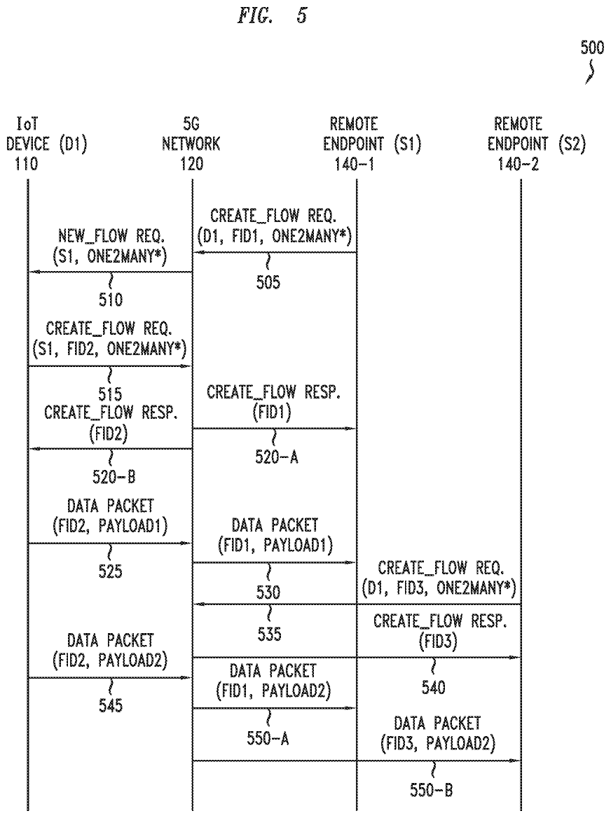

The flow-based communications between the IoT device 110 and the one or more remote endpoints may utilize an O2O communication mode. This may be a unidirectional or bidirectional data flow between a pair of endpoints. The IoT device 110 may be the source endpoint or destination endpoint of the data being communicated. For example, the O2O mode may be used where a sensor wants to regularly report sensor data to a server for storage and processing. For example, the O2O mode may be used where controller wants to guide a robot through rough terrain by reacting to obstacle data received from the robot. An example of the messaging for flow setup and flow forwarding for the O2O case (in which the IoT device 110 is the source endpoint of the data being communicated) is presented in FIG. 4.

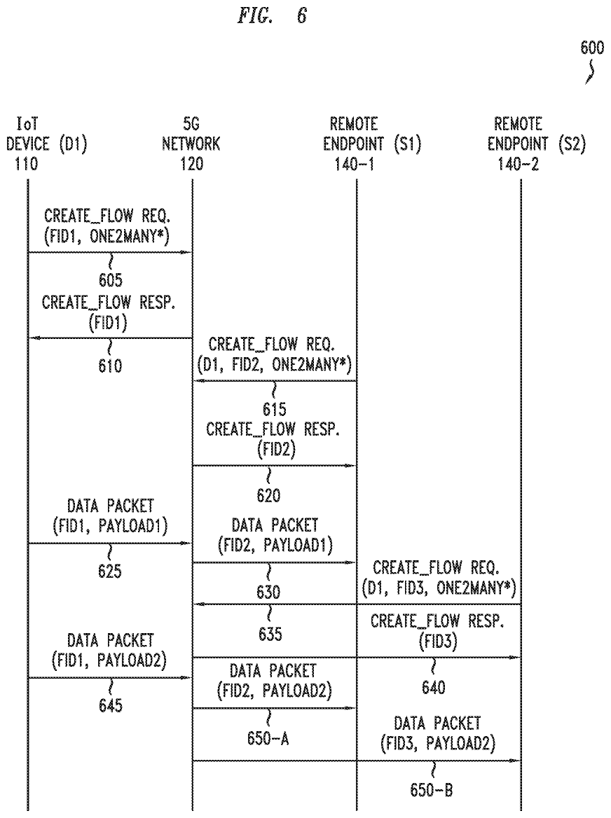

The flow-based communications between the IoT device 110 and the one or more remote endpoints may utilize an O2M communication mode. This may be a unidirectional data flow between a source endpoint and multiple destination endpoints. This may be thought of as being similar to a multicast. The IoT device 110 may be the source endpoint or one of the multiple destination endpoints of the data being communicated. For example, the O2M mode may be used where a thermometer provides its temperature data to a thermostat and a weather monitor. For example, the O2M mode may be used where a robot controller sends instructions to multiple robots. Examples of the messaging for flow setup and flow forwarding for the O2M case (in which the IoT device 110 is the source endpoint of the data being communicated) are presented in FIGS. 5 and 6.

The flow-based communications between the IoT device 110 and the one or more remote endpoints may utilize an M2O communication mode. This may be a unidirectional data flow between multiple source endpoints and a single destination endpoint. The IoT device 110 may be one of the source endpoints or may be the destination endpoint of the data being communicated. For example, the M2O mode may used where multiple thermometers provides their temperature data to a weather monitor. For example, the M2O mode may be used where a robot controller receives data from multiple robots. The messaging for flow setup and flow forwarding for the M2O case may be further understood by considering the messaging FIG. 4-FIG. 6.

The flow-based communications between the IoT device 110 and the one or more remote endpoints, utilizing any of the various communication modes, may be considered to be part of a single flow session having multiple flow legs associated therewith.

The flow session may be established responsive to various types of requests from various types of endpoints. For example, the flow session may be established responsive to a request of the IoT device 110 (e.g., in a O2O mode where the IoT device 110 requests a flow session to provide IoT device data to a remote endpoint, in a O2M mode where the IoT device requests a flow session to provide IoT device data to multiple remote endpoints, or the like), responsive to a request of a different IoT device (e.g., in a M2O mode where the different IoT device initiates the flow session and the IoT device 110 discovers and joins the flow session later), by a remote endpoint (e.g., in a O2O mode where the remote endpoint requests a flow session to receive IoT device data from the IoT device 110, in a O2M mode where the remote endpoint requests a flow session to provide IoT control data to the IoT device 110 and one or more other IoT devices, in a M2O mode where the remote endpoint requests a flow session to receive IoT device data from the IoT device 110 and one or more other IoT devices, or the like), or the like.

The flow session, as noted above, may be established responsive to various types of requests from various types of endpoints. The information that is needed or used to establish a flow session may depend on various factors, such as the endpoint types of the endpoints participating in the flow session, the communication mode that is being used for the flow session, which endpoint is initiating establishment of the flow session, or the like, as well as various combinations thereof. For example, for a O2O flow session between the IoT device 110 and a remote endpoint where the O2O flow session is initiated by the remote endpoint, the remote endpoint may obtain a network endpoint for the IoT device 110 (e.g., IP address, port number, network protocol, or the like) from the 5G network 120 (e.g., the network endpoint of the IoT device 110 is maintained by the 5G network 120 on behalf of the IoT device 110 and is discoverable by the remote endpoint) and send a flow setup request to the 5G network 120 (e.g., using an IP-based flow setup message if the remote endpoint is an IP device, using a layer-2-based flow setup message if the remote endpoint is an IP device and packet overhead optimization is to be performed, using a layer-2-based flow setup message if the remote endpoint is a non-IP device, or the like). For example, for an O2M flow session between the IoT device 110 and multiple remote endpoints where the IoT device 110 sources the data and the O2M flow session is initiated by the IoT device 110, the remote endpoints may specify the network endpoints (e.g., IP address, port number, network protocol, or the like) where they may receive the data sourced by the IoT device 110 (and it is noted that such network endpoints may be IP or non-IP 5G devices). For example, for a M2O flow session between multiple IoT devices and a single remote endpoint, the IoT device 110 may be asked by the remote endpoint to join the existing flow session based on discovery by the remote endpoint of the capabilities of the IoT device 110. It will be appreciated, at least from the foregoing examples, that the information that is used to initiate establishment of the flow session may be discoverable (or otherwise obtainable) from the 5G network 120 (even for other scenarios involving flow session establishment that are not addressed by the examples provided above).

The flow session may be established based on various types of information, which may vary depending on various factors, such as the endpoint types of the endpoints participating in the flow session, the communication mode that is being used for the flow session, which endpoint is initiating establishment of the flow session, or the like, as well as various combinations thereof. For example, for a remote endpoint (e.g., an IoT consumer device) that is requesting access to a capability or information of the IoT device 110, the request of the remote endpoint needs to include information that is sufficient to uniquely identify and access the capability or information of the IoT device 110 that is being requested, such as the GUID of the IoT device 110, an indication of the capability or information of the IoT device 110 being requested (e.g., temperature data if the remote endpoint only needs temperature data), and an access token (e.g., credentials for authorization). The request also may include an indication of the communication mode requested (e.g., O2O, O2M, or the like) or other types of information. In at least some embodiments, in which the requesting device is an external server, the external server may use Application Programming Interfaces (APIs) of the 5G network 120 to subscribe to a device data stream of the IoT device 110 by specifying both the set of parameters to uniquely identify the stream (e.g., as described above) as well as by specifying how and where the external server intends to receive the data from the stream (and, optionally, other information, such as the protocol that can be used to send the data (e.g., TCP or UDP)). In at least some embodiments, an external server may setup an O2O connection with the IoT device 110 by requesting from the 5G network 120 a network address for the IoT device 110 (e.g., via 5G network APIs) from where a device capability of the IoT device 110 can be accessed and then connecting with the device capability of the IoT device 110 by sending a flow setup request using standard IP protocols (e.g., TCP/IP or UDP/IP), in which case the 5G network 120 may temporarily assign to the IoT device 110 a unique network address (e.g., a UDP port or an IP address) for the duration of the flow (this address is not assigned to the IoT device 110) and the 5G network 120 handles the flow request on behalf of the IoT device 110 on this address and, once the flow is setup, forwards any packets received/sent for/from the IoT device 110 for this flow over layer-2 within the 5G network 120. It will be appreciated that these and various other embodiments of flow session establishment may be further understood by way of reference to FIGS. 4-6.

The flow session that is established, as noted above, has multiple flow legs. The number and arrangement of flow legs supported for the flow session may depend on various factors, such as the number of endpoints involved (and, thus, the communication mode), the locations of the endpoints involved, or the like, as well as various combinations thereof. The flow legs of a flow session may be established contemporaneously, at different times (e.g., one or more being pre-established, one or more being added to the flow session after the flow session is initially established, or the like), or the like, as well as various combinations thereof. The flow legs of a flow session also may be terminated at various times. The flow legs of a flow session may be added and removed dynamically; however, it will be appreciated that it is expected that at least two flow legs must be active in a flow session in order for data to flow end-to-end within the flow session.

The flow legs of a flow session may be uniquely identified using flow identifiers (FIDs) associated with the flow legs. The flow legs supported by the 5G network 120 may be uniquely identified across flow sessions based on a combination of the unique device identifier (e.g., MAC address) of the device of the flow leg (e.g., unique device identifier of the IoT device 110, unique device identifier of the RE 140, or the like) and the FID of the flow leg. The FID of a flow leg of a device (e.g., IoT device 110, RE 140, or the like) is configured to uniquely identify the flow leg at the 5G network 120 for that device and, accordingly, needs to be unique among the flow legs supported for the device. The FID of a flow leg of a device is allocated by the device and communicated to the 5G network 120 during flow session establishment, such that the 5G network 120 may maintain a mapping of the unique device identifier of the device and the FID for the flow leg of the device. The FID of a flow leg of a device is included in each of the packets sent over the flow leg of the device, namely, in each of the packets sent by the device for that flow leg (e.g., sent from the IoT device 110 to the IoT gateway 123 in the 5G network 120, sent from an RE 140 to the IoT gateway 123 in the 5G network 120, or the like) and in each of the packets received by the device for that flow leg (e.g., sent from the IoT gateway 123 in the 5G network 120 to the IoT device 110, sent from the IoT gateway 123 in the 5G network 120 to an RE 140, or the like). The inclusion of the unique device identifier of the device and the FID of the flow leg of the device in packets sent to and from the device obviates the need for destination address information to be included in the packets (e.g., layer-2 destination address) and, thus, reduces overhead (since the FID is smaller than the destination address information that would otherwise be included in the packets). The inclusion of the unique device identifier of the device and the FID of the flow leg of the device in packets sent to and from the device also may obviate the need for inclusion of other types of information in the packets (e.g., TCP/UDP port, source/destination IP, or the like). As such, a device (e.g., IoT device 110, RE 140, IoT gateway 123, or the like) sending a packet over a flow leg may send the packet while excluding certain types of information (e.g., destination address information and, optionally, other information) from the packet (which also may be considered to be preventing inclusion of such information within the packet). The size of the FID may be selected based on various factors, such as the number of flows to be supported by the device or the like. For example, the FID may be a four-bit identifier (e.g., if the devices are not expected to support more than sixteen flows), a one-byte identifier (e.g., if the devices are not expected to support more than 256 flows), or the like. In any event, the size of the FID is expected to provide a significant savings over use of the destination address in the packets (e.g., MAC destination addresses are 6 bytes), especially for relatively small packets that are often exchanged within the context of IoT systems.

The flow endpoints are configured to maintain flow leg state information. The flow endpoints maintain flow leg state information for any flow legs for which they are an endpoint (i.e., for their own flow legs). The flow leg state information that is maintained at a device for a flow leg may include a mapping of the FID allocated by the device for the flow leg to a unique device identifier of the device with which the flow leg is associated. It will be appreciated that the flow leg state information may include other types of state information which may be stored by a device for its flow legs.

The 5G network 120 is configured to maintain flow session state information for a flow session that has been established or is in the process or being established. This flow session state information may be maintained by the IoT gateway 123 or otherwise accessible to the IoT gateway 123. The flow session state information for the flow session includes flow leg state information for each of the flow legs of the flow session, such that the 5G network 120 can route packets between flow legs of the flow session (which may include translations of information transported within the packets on the flow legs of the flow session). For example, the flow session state information for a flow session may include mappings between the flow legs of the flow session. For example, the flow leg state information for a flow leg of a flow session may include flow leg identification information (e.g., matching information which may be used to identify the flow leg over which an incoming packet is received) and flow leg action information (e.g., rule information indicative of handling of a packet received via the identified flow leg, such as an indication of one or more other flow legs over which the packet is to be sent). For example, for an O2O flow session having two flow legs (e.g., a first flow leg of a first device having a unique device identifier of MAC_address-11 and flow identifier of FID3 and a second flow leg of a second device having a unique device identifier of MAC_address23 and FID6), the flow session state information may include a mapping between the two flow legs (e.g., received packets including MAC_address-11 and FID3 are modified to include MAC_address23 and FID6 for forwarding over the other flow leg and, similarly, received packets including MAC_address23 and FID6 are modified to include MAC_address-11 and FID3 for forwarding over the other flow leg). It will be appreciated that the flow session state information for a flow session may support various other numbers of mappings depending on the networking mode (e.g., O2M, M2O, or the like).

It will be appreciated that, although communication system 100 is primarly presented herein as being based on an SDN-based based implementation of a 5G network, communication system 100 may be based on other types of networking, other types of communication networks (e.g., other types of wireless networks, wireline networks, or the like, as well as various combinations thereof), or the like, as well as various combinations thereof.

FIG. 4 depicts an example message flow, based on the communication system of FIG. 1, for supporting device networking for an IoT device based on a one-to-one communication mode.

As depicted in FIG. 4, message flow 400, for supporting device networking for an IoT device (e.g., IoT device 110 of FIG. 1), is configured to support flow session establishment and data transfer for the IoT device, using the 5G network (e.g., 5G network 120 of FIG. 1) based on an O2O communication mode for a flow session including a remote endpoint (e.g., an RE 140 of FIG. 1).

At step 405, the remote endpoint initiates establishment of the flow session for the IoT device by sending a Create_Flow request to the 5G network. The Create_Flow request may be included in the payload of a packet sent by the remote endpoint. The Create_Flow request includes the GUID of the IoT device with which the remote endpoint is requesting to establish the flow session (e.g., indicated as D1 in FIG. 4). The Create_Flow request includes an FID selected by the remote endpoint for its flow leg between the remote endpoint and the 5G network (e.g., indicated as FID1 in FIG. 4). The Create_Flow request also may include one or more additional parameters. The one or more additional parameters may include an indication of the flow type requested for the flow session (in this example, an O2O flow session type), an indication of the type of data to be exchanged on the flow session (e.g., temperature data, humidity data, or the like), authorization information for use in authorizing the remote endpoint (e.g., an access token or other suitable type of authorization information), or the like, as well as various combinations thereof. It is noted that, for purposes of clarity, only the flow type is depicted in FIG. 4.

At step 410, the 5G network sends a New_Flow request to the IoT device specified in the Create_Flow request from the remote endpoint. The 5G network may send the New_Flow request to the IoT device based on a determination that the flow request of the remote endpoint is authorized (e.g., that the remote endpoint is authorized to establish a flow session with the IoT device). The New_Flow request may be included in the payload of a packet sent by the 5G network. The New_Flow request includes the GUID the remote endpoint that is requesting to establish the flow session (e.g., indicated as S1 in FIG. 4). The New_Flow request also may include some or all of the additional parameters included in the Create_Flow request of the remote endpoint (e.g., flow type, data type, or the like), although only the flow type is depicted in FIG. 4 (for purposes of clarity).

At step 415, the IoT device sends a Create_Flow request to the 5G network. The IoT device may send the Create_Flow request to the 5G network based on a determination that the flow request of the remote endpoint is to be accepted (e.g., that the IoT device agrees to establishment of the flow session with the IoT device). The Create_Flow may be included in the payload of a packet sent by the IoT device. The header of the packet sent by the IoT device includes the unique device identifier of the IoT device. The Create_Flow request includes the GUID of the remote endpoint that is requesting to establish the flow session (e.g., the GUID of the remote endpoint, which is indicated as S1 in FIG. 4). The Create_Flow request includes an FID selected by the IoT device for its flow leg between the IoT device and the 5G network (e.g., in this example, denoted as FID2). The Create_Flow request also may include some or all of the additional parameters included in the New_Flow request received from the 5G network (e.g., flow type, data type, or the like), although only the flow type is depicted in FIG. 4 (for purposes of clarity).

At step 420, the 5G network, based on a matching of the flow legs of the remote endpoint and the IoT device, sends Create_Flow responses to the remote endpoint (denoted as step 420-A) and to the IoT device (denoted as step 420-B). The 5G network may match the flow legs of the flow session based on matching of the parameters included in the Create_Flow request sent by the remote endpoint and the Create_Flow request sent by the IoT device. The Create_Flow response sent to the remote endpoint at step 420-A includes the FID of the flow leg of the remote endpoint (namely, FID1) and, optionally, also may include a flow session status indicator that is indicative as to whether establishment of the flow session was successful. Similarly, the Create_Flow response sent to the IoT device at step 420-B includes the FID of the flow leg of the IoT device (namely, FID2) and, optionally, also may include a flow session status indicator that is indicative as to whether establishment of the flow session was successful. At this point, the flow session has been successfully established between the remote endpoint and IoT device such that these device may start exchanging data. It is noted that the 5G network also stores mapping information in order to map the flow legs to each other (e.g., a mapping between FID1 and FID2) and, thus, support communication of data between the IoT device and the remote endpoint using the flow identifiers of the flow legs.

At step 425, the IoT device sends IoT device data intended for delivery to the remote endpoint, over the flow session established between the IoT device and the remote endpoint. The IoT device sends the IoT device data to the 5G network on the flow leg between the IoT device and the 5G network. The IoT device sends the IoT device data to the 5G network using a data packet that includes a header and a payload. The header includes the unique device identifier of the IoT device and the FID of the flow leg of the IoT device (namely, FID2), which provides enough information for the 5G network to be able to direct the IoT device data of the IoT device to the remote endpoint for which the IoT device data is intended. The header excludes routable address information (e.g., destination address, such as destination MAC address or the like) of the remote endpoint (thereby providing significant savings over the air interface) since, as noted above, the combination of the unique device identifier of the IoT device and the FID of the flow leg of the IoT device is sufficient for the 5G network to be able to direct the IoT device data of the IoT device to the remote endpoint for which the IoT device data is intended. The payload includes the IoT device data being communicated from the IoT device to the remote endpoint (e.g., a temperature reading, a humidity reading, or the like), which is denoted as PAYLOAD.

At step 430, the 5G network receives the data packet from the IoT device and sends a corresponding data packet to the remote endpoint.

The 5G network receives the data packet from the IoT device. The 5G network modifies the header of the data packet, by replacing the unique device identifier of the IoT device with the layer-2 address (e.g., MAC address) assigned to the IoT device by the 5G network (e.g., by the 5G SDN controller), to provide thereby a modified data packet. The 5G network may modify the header of the data packet to provide the modified data packet based on a mapping of the unique device identifier of the IoT device to the layer-2 address of the IoT device. This may be performed by the BTS of the 5G network or by any other suitable entity of the 5G network (e.g., the BTS SDN switch or the like).

The 5G network determines that the modified data packet from the IoT device is intended for the remote endpoint. The 5G network determines that the modified data packet from the IoT device is intended for the remote endpoint based on mapping information maintained by the 5G network when the flow session is established (e.g., a mapping of a combination of the layer-2 address of the IoT device and the FID of the flow leg of the IoT device, which are included in the modified data packet, to a combination of the layer-2 address of the remote endpoint and the FID of the flow leg of the remote endpoint). The 5G network sends the IoT device data to the remote endpoint on the flow leg between the 5G network and the remote endpoint. The 5G network sends the IoT device data to the remote endpoint using a data packet that includes a header and a payload. The header includes the layer-2 address of the remote endpoint (e.g., MAC address) and the FID of the flow leg of the remote endpoint (namely, FID1), which the 5G network identifies based on the mapping information. The payload includes the IoT device data being communicated from the IoT device to the remote endpoint (e.g., a temperature reading, a humidity reading, or the like). The 5G network may generate the data packet by modifying the modified data packet (e.g., updating the layer-2 address information and replacing the FID of the IoT device (FID2) with the FID of the remote endpoint (FID1)), generating a new packet based on the modified data packet (e.g., copying the data packet received from the IoT device and modifying the copy of the data packet), or the like. It is noted that the new packet may be generated based on session and protocol information being maintained by the 5G network for the flow leg between the 5G network and the remote endpoint (e.g., in the case of this flow leg using TCP, full TCP session information that is being maintained by the 5G network is used to recreate the TCP payload). This may be performed by the IoT gateway of the 5G network (or by any other suitable entity of the 5G network).

It will be appreciated that, although omitted from FIG. 4 for purposes of clarity, message flow 400 may continue to operate as data is exchanged between the IoT device and the remote endpoint (e.g., until such a time that the flow session is terminated).

It will be appreciated that, although primarily presented with respect to embodiments in which the flow session is initiated by the remote endpoint and the IoT device is the source of the IoT device data being transmitted via the flow session, the flow session may be initiated by other devices (e.g., the IoT device), the remote endpoint also or alternatively may send data to the IoT device, or the like, as well as various combinations thereof.

It will be appreciated that, although primarily presented with respect to embodiments in which flow session establishment includes contemporaneous establishment of the two flow legs of the flow session, in at least some embodiments flow session establishment may be performed by linking the output data stream of one endpoint (e.g., the IoT device in message flow 400 of FIG. 4) to the input data stream of another endpoint (e.g., the remote endpoint in message flow 400 of FIG. 4). In at least some such embodiments, the FIDs may be pre-assigned to the flow legs of the flow session and, thus, it is expected that flow session establishment may be completed relatively quickly. It is noted that this data stream linking may be performed automatically, seamlessly based on an operator control panel, or the like.

FIG. 5 depicts an embodiment of a method for flow session establishment and data transfer for a one-to-many communication mode.

As depicted in FIG. 5, message flow 500, for supporting device networking for an IoT device (e.g., IoT device 110 of FIG. 1), is configured to support flow session establishment and data transfer for the IoT device, using the 5G network (e.g., 5G network 120 of FIG. 1) based on an O2M communication mode for a flow session including two remote endpoints (e.g., two REs 140 of FIG. 1). In message flow 500, the flow session establishment is initiated by one of the remote endpoints.

The steps 505-530 of FIG. 5 are similar to the steps 405-430 of FIG. 4; however, the flow type for the flow session is now indicated as being O2M (rather than O2O), as a second remote endpoint also joins the flow session in order to receive data of the IoT device (as discussed further below with respect to steps 535-550). Additionally, it is noted that the IoT device data sent by the IoT device in step 525 and forwarded to the remote endpoint in step 530 is marked as PAYLOAD1 so as to distinguish it from the IoT device data that is sent by the IoT device after the second remote endpoint joins the flow session (denoted as PAYLOAD2).

At step 535, the second remote endpoint initiates establishment of the flow session for the IoT device by sending a Create_Flow request to the 5G network. Here, the second remote endpoint initiates establishment of the flow session for the IoT device. The Create_Flow request may be included in the payload of a packet sent by the second remote endpoint. The Create_Flow request includes the GUID of the IoT device with which the remote endpoint is requesting to establish the flow session (e.g., indicated as D1 in FIG. 5). The Create_Flow request includes an FID selected by the second remote endpoint for its flow leg between the second remote endpoint and the 5G network (e.g., in this example, denoted as FID3). The Create_Flow request also may include one or more additional parameters. The one or more additional parameters may include an indication of the flow type requested for the flow session (in this example, an O2M flow session type), an indication of the type of data to be exchanged on the flow session (e.g., temperature data, humidity data, or the like), authorization information for use in authorizing the remote endpoint (e.g., an access token or other suitable type of authorization information), or the like, as well as various combinations thereof. It is noted that, for purposes of clarity, only the flow type is depicted in FIG. 5.

At step 540, the 5G network, based on a determination that the flow leg to the IoT device for the flow session requested by the second remote endpoint has already been established, sends a Create_Flow response to the second remote endpoint.

The determination that the flow leg to the IoT device for the flow session requested by the second remote endpoint has already been established may be based on comparison of the one or more additional parameters included in the Create_Flow request received from the second remote endpoint and the one or more additional parameters associated with the flow leg to the IoT device. For example, where the IoT device is currently involved in multiple flow sessions—such as an O2O flow session sending humidity data to a server and the O2M flow session sending temperature data to the first remote endpoint (which is the flow session in which the second remote endpoint would like to participate)—a combination of the GUID of the IoT device and the one or more additional parameters that are included in the Create_Flow request from the second endpoint enable the 5G network to identify the O2M flow session in which the second remote endpoint would like to participate such that the 5G network may initiate messaging to enable the second remote endpoint to join the O2M flow session (rather than initiating messaging to establish the flow session, as was done for the first remote endpoint in steps 505-530). In this manner, the existing flow leg of the IoT device is reused, within the context of the O2M flow session, to support delivery of the IoT device data of the IoT device to the second remote endpoint.

The Create_Flow response sent to the second remote endpoint includes the FID of the flow leg of the second remote endpoint (namely, FID3) and, optionally, also may include a flow session status indicator that is indicative as to whether establishment of the flow session was successful. At this point, the flow leg for the second remote endpoint has been successfully added to the O2M flow session such that the IoT device and the second remote endpoint may start exchanging data. It is noted that the 5G network also stores mapping information in order to map the flow legs to each other (e.g., a mapping between a combination of the layer-2 address of the IoT device and FID2 of the flow leg of the IoT device and a combination of the layer-2 address of the second remote endpoint and FID3 of the flow leg of the second remote endpoint) and, thus, support communication of data between the IoT device and the second remote endpoint using the FIDs of the flow legs.

At step 545, the IoT device sends data intended for delivery to the remote endpoint and the second endpoint, over the flow session established between the IoT device and the remote endpoint and the second remote endpoint. The IoT device sends the IoT device data to the 5G network on the flow leg between the IoT device and the 5G network. The IoT device sends the IoT device data to the 5G network using a data packet that includes a header and a payload. The header includes the unique device identifier of the IoT device and the FID of the flow leg of the IoT device (namely, FID2), which provides enough information for the 5G network to be able to direct the IoT device data of the IoT device to the remote endpoint and the second remote endpoint for which the IoT device data is intended. The header excludes routable address information (e.g., destination addresses, such as destination MAC addresses or the like) of the remote endpoint and the second remote endpoint (thereby providing significant savings over the air interface) since, as noted above, the combination of the unique device identifier of the IoT device and the FID of the flow leg of the IoT device is sufficient for the 5G network to be able to direct the IoT device data of the IoT device to the remote endpoint and second remote endpoint for which the IoT device data is intended. The payload includes the IoT device data being communicated from the IoT device to the remote endpoint (e.g., a temperature reading, a humidity reading, or the like), which is denoted as PAYLOAD2.

At step 550, the 5G network receives the data packet from the IoT device and sends a corresponding data packet to the remote endpoint (denoted as step 550-A) and sends a corresponding data packet to the second remote endpoint (denoted as step 550-B).

The 5G network receives the data packet from the IoT device. The 5G network modifies the header of the data packet, by replacing the unique device identifier of the IoT device with the layer-2 address (e.g., Ethernet MAC address) assigned to the IoT device by the 5G network (e.g., by the 5G SDN controller), to provide thereby a modified data packet. The 5G network may modify the header of the data packet to provide the modified data packet based on a mapping of the unique device identifier of the IoT device to the layer-2 address of the IoT device. This may be performed by the BTS of the 5G network or by any other suitable entity of the 5G network (e.g., the BTS SDN switch or the like).

The 5G network determines that the modified data packet from the IoT device is intended for both the remote endpoint and the second remote endpoint. The 5G network determines that the modified data packet from the IoT device is intended for both the remote endpoint and the second remote endpoint based on mapping information maintained by the 5G network for the flow session (e.g., a mapping of a combination of the layer-2 address of the IoT device and the FID of the flow leg of the IoT device (FID2), which is included in the modified data packet, to (1) a combination of the layer-2 address of the remote endpoint and the FID of the flow leg of the remote endpoint (FID1) and (2) a combination of the layer-2 address of the second remote endpoint and the FID of the flow leg of the second remote endpoint (FID3)). The 5G network sends the IoT device data to the remote endpoint on the flow leg between the 5G network and the remote endpoint and sends the IoT device data to the second remote endpoint on the flow leg between the 5G network and the second remote endpoint. This may be performed by the IoT gateway of the 5G network (or by any other suitable entity of the 5G network).

The 5G network sends the IoT data to the remote endpoint using a data packet that includes a header and a payload. The header includes the layer-2 address of the remote endpoint (e.g., MAC address) and the FID of the flow leg of the remote endpoint (namely, FID1), which the 5G network identifies based on the mapping information. The payload includes the data being communicated from the IoT device to the remote endpoint (e.g., a temperature reading, a humidity reading, or the like), which, again, is denoted as PAYLOAD2.

The 5G network sends the IoT data to the second remote endpoint using a data packet that includes a header and a payload. The header includes the layer-2 address of the second remote endpoint (e.g., MAC addresses) and the FID of the flow leg of the second remote endpoint (namely, FID3), which the 5G network identifies based on the mapping information. The payload includes the data being communicated from the IoT device to the second remote endpoint (e.g., a temperature reading, a humidity reading, or the like), which, again, is denoted as PAYLOAD2.

The 5G network may generate the data packets for the remote endpoint and the second remote endpoint, respectively, in various ways. The 5G network may generate the data packets by copying the modified data packet once, modifying the modified data packet (e.g., creating the data packet for the remote endpoint by removing the layer-2 address of the IoT device, adding the layer-2 address of the remote endpoint, and replacing the FID of the flow leg of the IoT device (FID2) with the FID of the flow leg of the remote endpoint (FID1)), and modifying the copy of the data packet (e.g., replacing the FID of the flow leg of the IoT device (FID2) with the FID of the flow leg of the second remote endpoint (FID3) to create the data packet for the second remote endpoint). The 5G network may generate the data packets by copying the modified data packet twice (e.g., and modifying the two copies of the data packet to create the two data packets that are sent to the remote endpoint and the second remote endpoint). It is noted that the packets may be generated based on respective session and protocol information being maintained by the 5G network for the respective flow legs between the 5G network and the remote endpoint and the second remote endpoint (e.g., in the case of a flow leg using TCP, full TCP session information that is being maintained by the 5G network is used to recreate the TCP payload for the packet generated for that flow leg). The 5G network may generate the data packets in various other ways.

It will be appreciated that, although omitted from FIG. 5 for purposes of clarity, method 500 may continue to operate as data is exchanged between the IoT device and the remote endpoint and the second remote endpoint (e.g., until such a time that the flow session is terminated).

It will be appreciated that, although primarily presented with respect to embodiments in which the flow session is initiated by the remote endpoint and the IoT device is the source of the data being transmitted via the flow session, the flow session may be initiated by other devices (e.g., the IoT device, the second remote endpoint, or the like), the remote endpoint also or alternatively may send data to the IoT device, the second remote endpoint also or alternatively may send data to the IoT device, or the like, as well as various combinations thereof. It is noted that an embodiment in which the flow session is initiated by the IoT device and the IoT device is the source of data transported on the flow session is presented with respect to FIG. 6.

FIG. 6 depicts an embodiment of a method for flow session establishment and data transfer for a one-to-many communication mode.

As depicted in FIG. 6, message flow 600, for supporting device networking for an IoT device (e.g., IoT device 110 of FIG. 1), is configured to support flow session establishment and data transfer for the IoT device, using the 5G network (e.g., 5G network 120 of FIG. 1) based on an O2M communication mode for a flow session including two remote endpoints (e.g., two REs 140 of FIG. 1). In message flow 600, the flow session establishment is initiated by the IoT device.

At step 605, the IoT device initiates establishment of the flow session by sending a Create_Flow request to the 5G network. The Create_Flow request may be included in the payload of a packet sent by the IoT device. The header of the packet sent by the IoT device includes the unique device identifier of the IoT device. The Create_Flow request includes an FID selected by the IoT device for its flow leg between the IoT device and the 5G network (e.g., in this example, denoted as FID1). The Create_Flow request also may include one or more additional parameters. The one or more additional parameters may include an indication of the flow type requested for the flow session (in this example, an O2M flow session type), an indication of the type of data to be exchanged on the flow session (e.g., temperature data, humidity data, or the like), or the like, as well as various combinations thereof. The Create_Flow request does not include the GUID of a remote endpoint as the IoT device is initiating establishment of the flow session which may later be joined by one or more remote endpoints. It is noted that, for purposes of clarity, only the flow type is depicted in FIG. 6.

At step 610, the 5G network sends a Create_Flow response to the IoT device. The Create_Flow response sent to the IoT device includes the FID of the flow leg of the IoT device (namely, FID1) and, optionally, also may include a flow session status indicator that is indicative as to whether establishment of the flow session was successful. At this point, the flow leg for the IoT device has been established such that the IoT device may start sending IoT data; however, at this point, no remote endpoints have requested flows to receive the IoT data of the IoT device. These requests from remote devices may be initiated at any later time, and are discussed with respect to steps 615-650.

The steps 615-650 of FIG. 6 are similar to the steps 505 and 520-A (for the remote endpoint) and steps 535 and 540 (for the second remote endpoint) of FIG. 5; however, here, both the remote endpoint and the second remote endpoint are requesting flow legs to receive IoT data from an IoT device that already had a flow leg established. As a result, as noted above, steps 615-650 may be performed at any time after step 610 is completed (e.g., one minute later, one day later, one week later, or the like). In at least some embodiments, following establishment of the flow leg for the IoT device, the 5G network may provide information indicative of the availability of the flow leg to the IoT device, which may be discovered by the remote endpoints and used by the remote endpoints to request flow legs to be connected to the flow leg of the IoT device. In at least some embodiments, the 5G network may control when the IoT device starts sending data. For example, depending on whether or not any remote endpoint has a flow leg associated with the flow leg created for the IoT device (and, optionally, information indicative as to when a remote endpoint will or may establish such a flow leg), the 5G network may send a Hold Data message to the IoT device to instruct the IoT device not to send IoT data over its flow leg and may send a Send Data message to the IoT device to instruct the IoT device to send IoT data over its flow leg (e.g., when a remote endpoint establishes, or request establishment of, a flow leg). The IoT device will be configured to send or hold data as instructed by the 5G network. The establishment of the flow leg for the remote endpoint (in steps 615 and 620) completes the flow session establishment for the remote endpoint such that IoT data may flow from the IoT device to the remote endpoint via the flow legs (as in steps 625 and 630) and, similarly, the establishment of the flow leg for the second remote endpoint (in steps 635 and 640) completes the flow session establishment for the second remote endpoint such that IoT data may flow from the IoT device to the second remote endpoint via the flow legs (as in steps 645 and 650).

It will be appreciated that, although not illustrated, flow establishment may be performed for establishment of M2O flow sessions. In a M2O flow session, the data is propagated from multiple source endpoints to a single destination endpoint (e.g., toward an IoT device from multiple remote endpoints or toward a remote endpoint from multiple IoT devices) and, as such, the M2O flow session may be composed of multiple flow legs from the multiple source endpoints to the 5G network and a single flow leg from the 5G network to the destination endpoint). The flow legs for M2O flow sessions may be established in a manner similar to that described for O2M sessions, which may vary depending on which device(s) initiate the establishment of the M2O flow sessions, the flow direction, or the like, as well as various combinations thereof. The flow data received by the 5G network via the multiple flow legs from the source endpoints to the 5G network may be forwarded by the 5G network to the destination endpoint via the single flow leg from the 5G network to the destination endpoint. The flow data received by the 5G network via the multiple flow legs from the source endpoints to the 5G network is not expected to include the GUIDs of the source endpoints (rather, the FIDs of the flow legs, respectively) and, as such, the 5G network may insert GUIDs of the source endpoints (which may be determined by the 5G network using mapping information that maps the FIDs of the flow legs of the source endpoints to the GUIDs of those source endpoints, respectively) into the packets sent to the destination endpoint via the single flow leg between the 5G network and the destination endpoint to enable the destination endpoint to distinguish the sources of the packets from the source endpoints. It is noted that transmission of the GUIDs of the source endpoints by the 5G network may depend on the options that are available from the underlying communication protocol. For example, if the flow leg from the 5G network to the destination endpoint is using TCP, the GUIDs of the source endpoints may be sent as TCP Options in the packet headers of the source endpoints.

It will be appreciated that, although not illustrated, flow establishment may be performed for establishment of M2M flow sessions. In a M2M flow session, the data is propagated from multiple source endpoints to a multiple destination endpoints (e.g., toward multiple IoT devices from multiple remote endpoints or toward multiple remote endpoints from multiple IoT devices) and, as such, the M2M flow session may be composed of multiple flow legs from the multiple source endpoints to the 5G network and multiple flow leg from the 5G network to the multiple destination endpoints). The flow legs for M2M flow sessions may be established in a manner similar to that described for O2M and M2O sessions, which may vary depending on which device(s) initiate the establishment of the M2O flow sessions, the flow direction, or the like, as well as various combinations thereof. The flow data received by the 5G network via the multiple flow legs from the source endpoints to the 5G network may be forwarded by the 5G network to the multiple destination endpoint via multiple single flow legs from the 5G network to the destination endpoints. The flow data received by the 5G network via the multiple flow legs from the source endpoints to the 5G network is not expected to include GUIDs of the source endpoints (rather, the FIDs of the flow legs, respectively) and, as such, the 5G network may insert GUIDs of the source endpoints (which may be determined by the 5G network using mapping information that maps the FIDs of the flow legs of the source endpoints to the GUIDs of those source endpoints, respectively) into the packets sent to the destination endpoints via the multiple flow legs between the 5G network and the destination endpoints to enable the destination endpoints to distinguish the sources of the packets from the source endpoints. It is noted that transmission of the GUIDs of the source endpoints by the 5G network may depend on the options that are available from the underlying communication protocol. For example, if the flow leg from the 5G network to the destination endpoint is using TCP, the GUIDs of the source endpoints may be sent as TCP Options in the packet headers of the source endpoints.

It will be appreciated that, although omitted (e.g., from FIGS. 4, 5, and 6) for purposes of clarity, the 5G network may be configured to handle translations between the underlying network protocols that are used on the respective flow legs of the flow session and, thus, may support communication between endpoints that are using different underlying network protocols (which, as discussed herein, also may include support for IP and non-IP endpoints). For example, the 5G network, for packets received over a first flow leg that are to be sent over a second flow leg where the first flow leg and the second flow leg use different underlying network protocols, may be configured to process and translate the packets between the protocols.

It will be appreciated that, although omitted (e.g., from FIGS. 4, 5, and 6) for purposes of clarity, protocol data may be associated with some or all of the flow legs of a flow session. The protocol data associated with flow legs of the flow session may be negotiated by the endpoint devices during flow setup. The protocol data associated with flow legs of the flow session may be used by the 5G network (e.g., the IoT gateway) or other network(s) in order to support protocol-specific processing and forwarding of data of the flow legs of the flow session. The protocol data may vary across different protocols. For example, where the remote endpoint is a server and the protocol of the flow leg for the server is TCP, the protocol data for the flow leg may include the TCP port number (application identifier) on the server to which the data flow from the IoT device is being provided. For example, in the machine-to-machine protocol PROFINET, protocol data may include virtual local area network (VLAN) tags used for privacy and security. It will be appreciated that other types of protocol data may be supported, other protocols may be supported, or the like, as well as various combinations thereof.

It will be appreciated that, although the flow setup and communication embodiments are primarily presented within the context of embodiments in which the various endpoints are all connected to the 5G network (and, more specifically, to the same IoT gateway) such that only two flow legs are needed between any pair of communicating endpoints of a flow session, the endpoints may be connected in various other ways (e.g., to different IoT gateways of the same network, to different IoT gateways of different networks (in which case the communications by the endpoints may cross connections between IoT gateways and possibly between network boundaries), or the like, as well as various combinations thereof) such that more than two flow legs may be needed between one or more pairs of communicating endpoints of a flow session. In at least some embodiments, for example, one of the endpoints may be assigned to a first IoT gateway of the 5G network and the other of the endpoints may be assigned to a second IoT gateway of the 5G network, in which case a connection may be established between the first IoT gateway and the second IoT gateway for transporting the data of the flow session between the first gateway and the second gateway. In at least some embodiments, for example, one of the endpoints may be assigned to an IoT gateway of the 5G network and the other of the endpoints may be assigned to a gateway of a different communication network, in which case a connection may be established between the IoT gateway of the 5G network and the gateway of the different communication network for transporting the data of the flow session between the IoT gateway of the 5G network and the gateway of the different communication network. In at least some embodiments, for example, one of the endpoints may be assigned to a gateway of the first network and the other of the endpoints may be assigned to a gateway of a second network where a third network is disposed between the first and second networks, in which case a first connection may be established between the gateway of the first network and a gateway of the third network and a second connection may be established between the gateway of the third network and the gateway of the second network for transporting the data of the flow session or in which case an end-to-end tunnel may be established between the gateway of the first network and the gateway of the third network via the intervening second network. It will be appreciated that, in at least some embodiments in the end-to-end flow session crosses network boundaries between multiple networks, each network may publish a network address (e.g., IP address, UDP port number, or the like) for the gateway of its network, such that the adjacent networks may connect to the network address to support cross-boundary flows.

It will be appreciated that any suitable number of connections may be chained together to support end-to-end data flow (e.g., for crossing network boundaries of any suitable number of networks which may be disposed between the endpoints of the data session). It will be appreciated that such additional network connections between gateways or other types of intermediate devices may be supported using various networking capabilities, such as layer-2 tunneling, layer-3 tunneling, or the like.

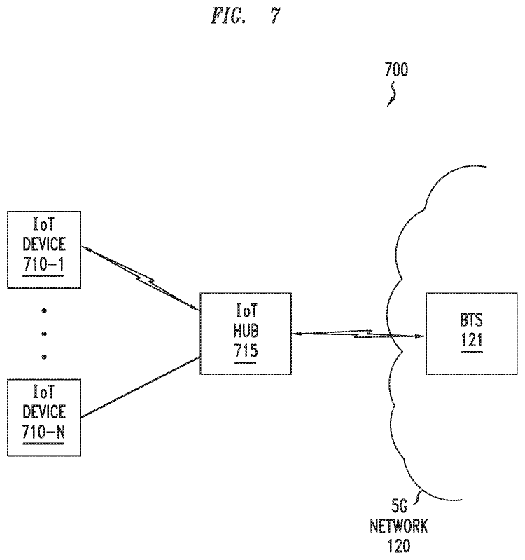

It will be appreciated that, although omitted for purposes of clarity, an IoT device (or multiple IoT devices) may be located behind a hub device (e.g., an IoT home gateway or other device which may support one or more associated IoT devices in the home). An example of an arrangement in which an IoT hub is serving multiple IoT devices is presented in FIG. 7.

FIG. 7 depicts an example of a portion of a communication system including an IoT hub configured to support communications of multiple IoT devices.

The communication system 700 includes a set of IoT devices 710-1-710-N (collectively, IoT devices 710), an IoT hub 715, and BTS 121 of 5G network 120. It will be appreciated that inclusion of BTS 121 of 5G network 120 is indicative that the arrangement of the IoT devices 710 and IoT hub 715 of the communication system 700 may be used within the context of the communication system 100 of FIG. 1 (although the remaining portions of communication system 100 are omitted from FIG. 7 for purposes of clarity).

The IoT hub 715 has a GUID associated therewith, which may be used for authentication and authorization of the IoT hub 715 with the 5G network 120. The IoT devices 710 have GUIDs associated therewith. The GUIDs of the IoT devices 710 may be used in various control messages that may be sent by the IoT hub 715 on behalf of the IoT devices 710 (e.g., for identifying the IoT devices 710 in authentication and authorization, registration, and discovery messages). The IoT devices 710 may register with the 5G network 120 themselves (based on their GUIDs) or the IoT hub 715 can register the IoT devices 710 by sending register messages for the IoT devices 710 using the GUIDs of the IoT devices 710.

The IoT hub 715 has a unique device identifier associated therewith (which may be used in place of unique device identifiers of the IoT devices 710 in the above-described embodiments in which IoT hub 715 is not present). The IoT devices 710 do not need unique device identifiers associated therewith. The unique device identifiers of the IoT devices 710 may not be used by the IoT hub 715 since, as noted above, the IoT hub 715 has a unique device identifier associated therewith (which, as previously indicated, may be used in place of unique device identifiers of the IoT devices 710 in the above-described embodiments in which IoT hub 715 is not present).

The IoT devices 710 have IoT device identification information associated therewith, which is configured for use by the IoT hub 715 to uniquely identify the IoT devices 710 connected to the IoT hub 715. The IoT hub 715 maintains IoT device identification information that is used by the IoT hub 715 to uniquely identify the IoT devices 710 connected to the IoT hub 715. The IoT device identification information used to support unique identification of the IoT devices 710 behind the IoT hub 715 may include any suitable number of bits (which may depend on the number of IoT devices 710 connected to the IoT hub 715 that need to be uniquely identified). For example, the IoT device identification information may be a four-bit identifier (e.g., if the IoT hub 715 has at most sixteen IoT devices 710 behind it), a one-byte identifier (e.g., if the hub has at most two-hundred and fifty-six IoT devices 710 behind it), or the like.

The upstream and downstream communication by IoT devices 710 via the IoT hub 720 is discussed further below.

In the upstream direction from an IoT device 710, the IoT device 710 sends a packet. The packet includes a header and a payload. The header includes IoT device identification information that may be used by the IoT hub 715 to uniquely identify the IoT device 710. The payload includes IoT device data of the IoT device 710 that is being provided to a consumer device(s). The IoT hub 715 receives the packet from the IoT device 710 and sends the packet to the 5G network 120. The packet of the IoT device 710 that is sent by the IoT hub 715 to the 5G network 120 may include the unique device identifier of the IoT hub 715 and the IoT device identification information that is used to uniquely identify the IoT device 710, as well as the FID of the flow leg between the IoT hub 715 and the 5G network 120. The BTS 121 of the 5G network 120, upon receiving the packet, identifies the layer-2 address of the IoT hub 715 based on the unique device identifier of the IoT hub 715 and inserts the layer-2 address of the IoT hub 715 into the packet and sends the packet into the 5G network 120. The 5G network 120 (e.g., the IoT gateway 123), upon receiving the packet including the layer-2 address of the IoT hub 715, identifies the flow session based on the layer-2 address of the IoT hub 715, the IoT device identification information of the IoT device 710, and the FID of the flow leg between the IoT hub 715 and the 5G network 120. The 5G network 120, based on identification of the flow session for the packet, retrieves flow session information associated with the identified flow session. The flow session information includes information uniquely identifying any other flow legs of the flow session on which the IoT device data of the IoT device 710 is to be sent (here, for purposes of clarity, assume that there is one other flow leg between the 5G network 120 and a consumer device of a consumer of the IoT device data). The other flow leg that is identified has associated therewith the layer-2 address of the consumer device and the FID for the other flow leg. The 5G network 120 replaces the FID in the packet with the retrieved FID for the other flow leg and sets the destination layer-2 address in the header to the layer-2 address of the consumer device to form thereby a modified packet (here it is assumed that the consumer device is directly connected to 5G, rather than being connected via a hub). The 5G network 120 sends the modified packet to the consumer device via the other flow leg.

In the downstream direction toward an IoT device 710, the 5G network 120 receives a packet of a consumer device that includes IoT device data to be delivered to the IoT device 710 (e.g., a request, a command, an instruction, or the like). The 5G network 120 receives the packet via a flow leg between the consumer device and the 5G network 120. The packet includes a header and a payload. The header of the packet includes the layer-2 address of the consumer device and the FID of the flow leg between the consumer device and the 5G network. The layer-2 address of the consumer device and the FID uniquely identify the flow session. The payload includes the IoT device data to be delivered to the IoT device 710. The 5G network 120, upon receiving the packet, identifies the flow session based on the layer-2 address of the consumer device and the FID and retrieves flow session information associated with the identified flow session. The flow session information includes information uniquely identifying any other flow legs of the flow session on which the IoT device data of the IoT device is to be sent (here, for purposes of clarity, assume that there is one other flow leg between the 5G network 120 and the IoT hub 715 supporting the IoT device 710 for which the packet of the consumer device is intended). The flow session information also includes IoT device identification information which may be used by the IoT hub 715 for uniquely identifying the IoT device 710. The other flow leg that is identified has associated therewith the layer-2 address of the IoT hub 715 and the FID for the other flow leg. The 5G network 120 replaces the FID in the packet with the retrieved FID for the other flow leg, sets the destination layer-2 address in the header to the layer-2 address of the IoT hub 715, inserts the IoT device identification information of the IoT device 710 into the packet (for use by the IoT hub 715 in identifying the IoT device 710 for which the packet is intended) to form thereby a modified packet. The 5G network 120 sends the modified packet to the IoT hub 715. The IoT hub 715 receives the modified packet and identifies the IoT device 710 for which the modified packet is intended based on the IoT device identification information of the IoT device 710. The IoT hub 715 provides the IoT device data to the IoT device 710 (e.g., by sending the modified packet to the IoT device, by sending a modified version of the modified packet to the IoT device 710, by extracting the IoT device data and providing the IoT device data to the IoT device, or the like).

It will be appreciated that various other functions may be provided for supporting use of IoT hub devices serving IoT devices or serving other types of endpoint devices or other types of intermediate device serving IoT devices or serving other types of endpoint devices.

It will be appreciated that, in general, the device that communicates with the BTS over the air may be referred to as an IoT-related device, which may be an IoT device where an IoT hub device is not present or which may be an IoT hub device supporting communications by one or more IoT devices. Various methods configured to support communications by IoT devices are discussed further below.

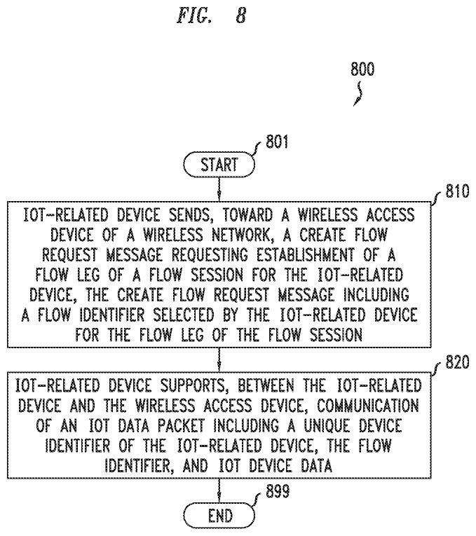

FIG. 8 depicts an example of a method for use by an IoT-related device in communicating via a wireless network. At block 801, method 800 begins. At block 810, the IoT-related device sends, toward a wireless access device of a wireless network, a create flow request message requesting establishment of a flow leg of a flow session for the IoT-related device, the create flow request message including a flow identifier selected by the IoT-related device for the flow leg of the flow session. It will be appreciated that the IoT-related device also may process an associated response to support establishment of the flow leg of the flow session for the IoT-related device. At block 820, the IoT-related device supports, between the IoT-related device and the wireless access device, communication of an IoT data packet including a unique device identifier of the IoT-related device, the flow identifier, and IoT device data. At block 899, method 800 ends.

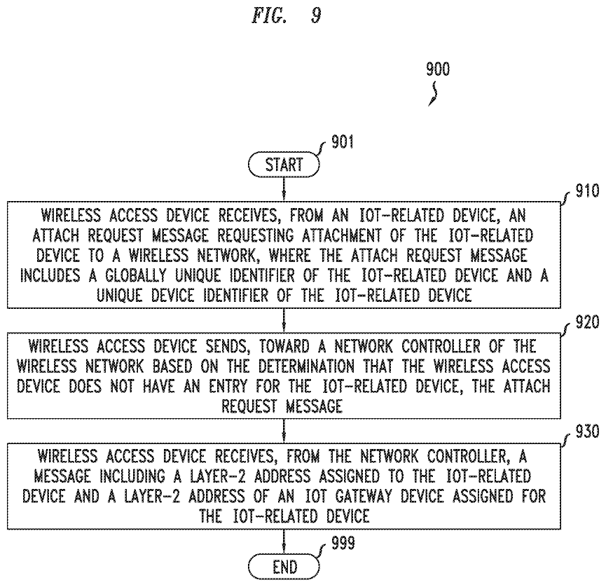

FIG. 9 depicts an example of a method for use by a wireless access device of a wireless network in supporting communications of an IoT-related device. At block 901, method 900 begins. At block 910, the wireless access device receives, from the IoT-related device, an attach request message requesting attachment of the IoT-related device to the wireless network, where the attach request message includes a globally unique identifier of the IoT-related device and a unique device identifier of the IoT-related device. At block 920, the wireless access device sends, toward a network controller of the wireless network based on a determination that the wireless access device does not have an entry for the IoT-related device, the attach request message. At block 930, the wireless access device receives, from the network controller, a message including a layer-2 address assigned to the IoT-related device and a layer-2 address of an IoT gateway device assigned for the IoT-related device. At block 999, method 900 ends.

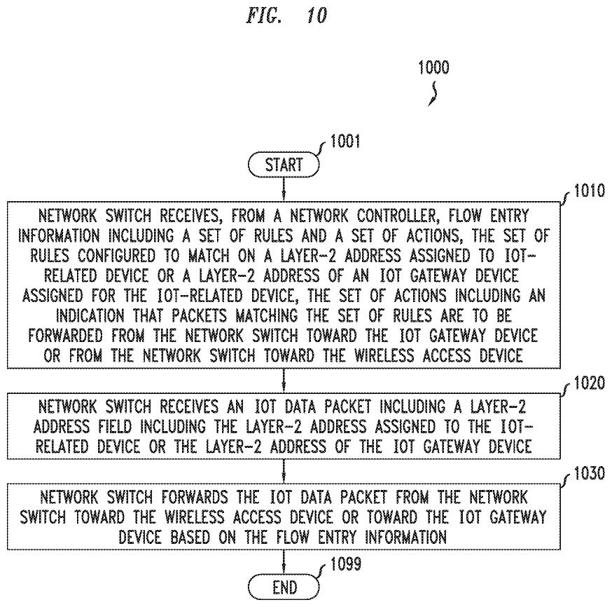

FIG. 10 depicts an example of a method for use by a network switch associated with a wireless access device in supporting communications of an IoT-related device. At block 1001, method 1000 begins. At block 1010, the network switch receives, from a network controller, flow entry information including a set of rules and a set of actions, the set of rules configured to match on a layer-2 address assigned to an Internet-of-Things (IoT)-related device or a layer-2 address of an IoT gateway device assigned for the IoT-related device, the set of actions including an indication that packets matching the set of rules are to be forwarded from the network switch toward the IoT gateway device or from the network switch toward the wireless access device. At block 1020, the network switch receives an IoT data packet including a layer-2 address field including the layer-2 address assigned to the IoT-related device or the layer-2 address of the IoT gateway device. At block 1030, the network switch forwards the IoT data packet from the network switch toward the wireless access device or toward the IoT gateway device based on the flow entry information. At block 1099, method 1000 ends.

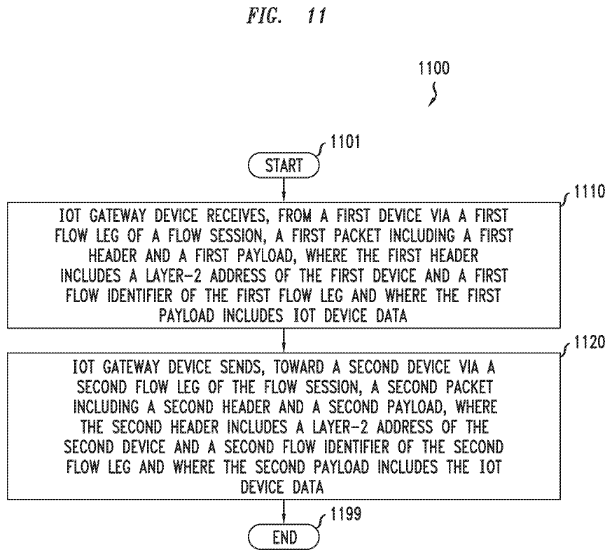

FIG. 11 depicts an example of a method for use by an IoT gateway device in supporting communications of an IoT-related device. At block 1101, method 1100 begins. At block 1110, the IoT gateway device receives, from a first device via a first flow leg of a flow session, a first packet including a first header and a first payload, where the first header includes a layer-2 address of the first device and a first flow identifier of the first flow leg and where the first payload includes IoT device data. At block 1120, the IoT gateway device sends, toward a second device via a second flow leg of the flow session, a second packet including a second header and a second payload, where the second header includes a layer-2 address of the second device and a second flow identifier of the second flow leg and where the second payload includes the IoT device data. At block 1199, method 1100 ends.

It will be appreciated that, although primarily presented with respect to embodiments in which networking is between IoT devices and IoT-related remote endpoints (e.g., IoT servers, IoT data consumers, or the like), various embodiments presented herein may be used for networking between IoT devices and non-IoT-related devices which may be located beyond the IoT gateway (e.g., devices in the core network, non-IoT servers, or the like, as well as various combinations thereof).

It will be appreciated that, although primarily presented herein with respect to supporting IoT device connectivity, discovery, and networking functions within the context of communication systems using specific types of communication networks and communication network technologies (e.g., 5G cellular networks and so forth), IoT device connectivity, discovery, and networking functions may be supported within the context of various other types of communication systems using various other types of communication networks (e.g., Fourth Generation (4G) cellular networks, Third Generation (3G) cellular networks, wireline networks, or the like, as well as various combinations thereof), various other types of communication network technologies, or the like, as well as various combinations thereof.

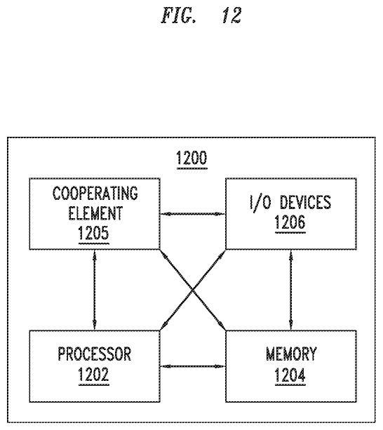

FIG. 12 depicts a high-level block diagram of a computer suitable for use in performing various functions described herein.

The computer 1200 includes a processor 1202 (e.g., a central processing unit (CPU), a processor having a set of processor cores, or the like) and a memory 1204 (e.g., a random access memory (RAM), a read only memory (ROM), or the like). The processor 1202 and the memory 1204 are communicatively connected.

The computer 1200 also may include a cooperating element 1205. The cooperating element 1205 may be a hardware device. The cooperating element 1205 may be a process that can be loaded into the memory 1204 and executed by the processor 1202 to implement functions as discussed herein (in which case, for example, the cooperating element 1205 (including associated data structures) can be stored on a non-transitory computer-readable storage medium, such as a storage device or other storage element (e.g., a magnetic drive, an optical drive, or the like)).

The computer 1200 also may include one or more input/output devices 1206. The input/output devices 1206 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 1200 of FIG. 12 may represent a general architecture and functionality suitable for implementing functional elements described herein, portions of functional elements described herein, or the like, as well as various combinations thereof. For example, computer 1200 may provide a general architecture and functionality that is suitable for implementing one or more of IoT device 110, an element of 5G network 120, BTS 121, BTS SDN switch 122, IoT gateway 123, 5G SDN controller 125, IoT device discovery system 129, an element of PDN 130, an RE 140, an IoT device 710, IoT hub 715, or the like.

It will be appreciated that the functions depicted and described herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions discussed herein as software methods may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

1. An apparatus, comprising:
at least one processor; and
at least one memory including computer program code;
wherein the at least one memory and the computer program code are configured to, with the at least one processor, cause the apparatus to at least:
send, by an Internet-of-Things (IoT)-related device toward a wireless access device of a wireless network, a create flow request message requesting establishment of a flow leg of a flow session for the IoT-related device, the create flow request message comprising a flow identifier selected by the IoT-related device for the flow leg of the flow session; and
support, between the IoT-related device and the wireless access device, communication of an IoT data packet including a unique device identifier of the IoT-related device, the flow identifier, and IoT device data.

2. The apparatus of claim 1, wherein a header of a packet including the create flow request message comprises the unique device identifier of the IoT-related device.

3. The apparatus of claim 1, wherein the unique device identifier of the IoT-related device comprises an layer-2 address of the IoT-related device or an identifier assigned by the wireless network for the IoT-related device.

4. The apparatus of claim 1, wherein the create flow request message comprises a globally unique identifier of a remote device.

5. The apparatus of claim 1, wherein the create flow request message is sent based on a determination by the IoT-related device to initiate establishment of the flow session.

6. The apparatus of claim 1, wherein the create flow request message is sent based on receipt of a new flow request message, the new flow request message comprising a globally unique identifier of a remote device.

7. The apparatus of claim 1, wherein the at least one memory and the computer program code are configured to, with the at least one processor, cause the apparatus to at least:
receive, by the IoT-related device from the wireless access device, a create flow response message associated with the create flow request message, the create flow response message comprising the flow identifier.

8. The apparatus of claim 1, wherein the IoT data packet is sent without including routable address information in the IoT data packet.

9. The apparatus of claim 1, wherein the IoT-related device comprises an IoT device.

10. The apparatus of claim 9, wherein, to support communication of the IoT data packet between the IoT device and the wireless access device, the at least one memory and the computer program code are configured to, with the at least one processor, cause the apparatus to at least:
obtain the IoT device data locally at the IoT device; and
send the IoT data packet from the IoT device toward the wireless access device.

11. The apparatus of claim 9, wherein, to support communication of the IoT data packet between the IoT device and the wireless access device, the at least one memory and the computer program code are configured to, with the at least one processor, cause the apparatus to at least:
receive the IoT data packet at the IoT device from the wireless access device; and
process the IoT device data locally at the IoT device.

12. The apparatus of claim 1, wherein the IoT-related device comprises an IoT hub device configured to support an IoT device.

13. The apparatus of claim 12, wherein, to support communication of the IoT data packet between the IoT hub device and the wireless access device, the at least one memory and the computer program code are configured to, with the at least one processor, cause the apparatus to at least:
receive, by the IoT hub device from the IoT device, the IoT device data; and
send the IoT data packet from the IoT hub device toward the wireless access device.

14. The apparatus of claim 12, wherein, to support communication of the IoT data packet between the IoT hub device and the wireless access device, the at least one memory and the computer program code are configured to, with the at least one processor, cause the apparatus to at least:
receive the IoT data packet at the IoT hub device from the wireless access device;
identify the IoT device; and
send the IoT device data from the IoT hub device toward the IoT device.

15. The apparatus of claim 1, wherein the at least one memory and the computer program code are configured to, with the at least one processor, cause the apparatus to at least one of:
send, by the IoT-related device toward the wireless access device, an attach request message requesting attachment of the IoT-related device to the wireless network, wherein the attach request message includes a globally unique identifier of the IoT-related device and the unique device identifier of the IoT-related device; or
send, by the IoT-related device toward the wireless access device, a registration message configured to register with the wireless network at least one of IoT device accessibility information or IoT device capability information.

16. An apparatus, comprising:
at least one processor; and
at least one memory including computer program code;
wherein the at least one memory and the computer program code are configured to, with the at least one processor, cause the apparatus to at least:
receive, by an Internet-of-Things (IoT) gateway device from a first device via a first flow leg of a flow session, a first packet comprising a first header and a first payload, wherein the first header comprises a layer-2 address of the first device and a first flow identifier of the first flow leg, wherein the first payload comprises IoT device data; and
send, by the IoT gateway device toward a second device via a second flow leg of the flow session, a second packet comprising a second header and a second payload, wherein the second header comprises a layer-2 address of the second device and a second flow identifier of the second flow leg, wherein the second payload comprises the IoT device data.

17. The apparatus of claim 16, wherein the at least one memory and the computer program code are configured to, with the at least one processor, cause the apparatus to at least:
identify, by the IoT gateway device based on the layer-2 address of the first device and the first flow identifier of the first flow leg, the second flow leg of the flow session.

18. The apparatus of claim 16, wherein the at least one memory and the computer program code are configured to, with the at least one processor, cause the apparatus to at least:
determine, by the IoT gateway device, that establishment of the flow session between the first device and the second device is authorized.

19. The apparatus of claim 16, wherein the at least one memory and the computer program code are configured to, with the at least one processor, cause the apparatus to at least:
receive, by the IoT gateway device from the first device, a create flow request message requesting establishment of the first flow leg, wherein the create flow request message comprises the first flow identifier;
send, by the IoT gateway device toward the first device based on the create flow request message, a create flow response message comprising the first flow identifier;
receive, by the IoT gateway device from the second device, a second create flow request message requesting establishment of the second flow leg, wherein the second create flow request message comprises the unique device identifier of the first device and the second flow identifier; and
send, by the IoT gateway device toward the second device based on the second create flow request message, a second create flow response message comprising the second flow identifier.

20. The apparatus of claim 16, wherein the at least one memory and the computer program code are configured to, with the at least one processor, cause the apparatus to at least:
receive, by the IoT gateway device from the second device, a create flow request message requesting establishment of the second flow leg, wherein the create flow request message comprises a globally unique identifier of the first device and the second flow identifier.

21. The apparatus of claim 20, wherein the at least one memory and the computer program code are configured to, with the at least one processor, cause the apparatus to at least:
send, by the IoT gateway device toward the first device based on the create flow request message, a new flow request message comprising a globally unique identifier of the second device;
receive, by the IoT gateway device from the first device, a second create flow request message requesting establishment of the first flow leg, wherein the second create flow request message comprises the globally unique identifier of the second device and the first flow identifier;
send, by the IoT gateway device toward the second device based on the create flow request message and the second create flow request message, a create flow response message comprising the second flow identifier; and
send, by the IoT gateway device toward the first device based on the create flow request message and the second create flow request message, a second create flow response message comprising the first flow identifier.

22. The apparatus of claim 16, wherein the at least one memory and the computer program code are configured to, with the at least one processor, cause the apparatus to at least:
receive, by the IoT gateway device from a third device, a create flow request message requesting establishment of a third flow leg of the flow session, wherein the create flow request message comprises a globally unique identifier of the first device and a third flow identifier of the third flow leg.

23. The apparatus of claim 16, wherein the at least one memory and the computer program code are configured to, with the at least one processor, cause the apparatus to at least:
send, by the IoT gateway device toward a third device via a third flow leg of the flow session, a third packet comprising a third header and a third payload, wherein the third header comprises a layer-2 address of the third device and a third flow identifier of the third flow leg, wherein the third payload comprises the IoT device data.

24. The apparatus of claim 16, wherein the at least one memory and the computer program code are configured to, with the at least one processor, cause the apparatus to at least:
send, by the IoT gateway device toward a second IoT gateway device, a third data packet comprising a third header and a third payload, wherein the third header comprises an address of the second IoT gateway device, wherein the third payload comprises the IoT device data.

25. The apparatus of claim 16, wherein the at least one memory and the computer program code are configured to, with the at least one processor, cause the apparatus to at least:
receive, by the IoT gateway device from the first device or the second device, a registration message configured to register with the wireless network at least one of IoT device accessibility information or IoT device capability information; and
send, by the IoT gateway device toward a device discovery system of the wireless network, the registration message.

26. The apparatus of claim 16, wherein the first packet is based on a first protocol and the second packet is based on a second protocol, wherein the at least one memory and the computer program code are configured to, with the at least one processor, cause the apparatus to at least:
perform a translation function to translate between the first protocol of the first packet and the second protocol of the second packet.

27. The apparatus of claim 16, wherein the p at least one memory and the computer program code are configured to, with the at least one processor, cause the apparatus to at least:
receive, by the IoT gateway device from the second device via the second flow leg of the flow session, a third packet comprising a third header and a third payload, wherein the third header comprises the layer-2 address of the second device and the second flow identifier of the second flow leg, wherein the third payload comprises additional IoT device data; and
send, by the IoT gateway device toward the first device via the first flow leg of the flow session, a fourth packet comprising a fourth header and a fourth payload, wherein the fourth header comprises the layer-2 address of the first device and the first flow identifier of the first flow leg, wherein the fourth payload comprises the additional IoT device data.

28. The apparatus of claim 16, wherein the first device is an IoT device and the IoT device data comprises IoT data of the IoT device or the second device is an IoT device and the IoT device data comprises IoT data intended for the IoT device.

29. An apparatus, comprising:
at least one processor; and
at least one memory including computer program code;
wherein the at least one memory and the computer program code are configured to, with the at least one processor, cause the apparatus to at least:
receive, by a wireless access device of a wireless network from an Internet-of-Things (IoT)-related device, an attach request message requesting attachment of the IoT-related device to the wireless network, wherein the attach request message includes a globally unique identifier of the IoT-related device and a unique device identifier of the IoT-related device;
send, by the wireless access device toward a network controller of the wireless network based on a determination that the wireless access device does not have an entry for the IoT-related device, the attach request message; and
receive, by the wireless access device from the network controller, a message including a layer-2 address assigned to the IoT-related device and a layer-2 address of an IoT gateway device assigned for the IoT-related device.

30. An apparatus, comprising:
at least one processor; and
at least one memory including computer program code;
wherein the at least one memory and the computer program code are configured to, with the at least one processor, cause the apparatus to at least:
receive, by a network switch associated with a wireless access device from a network controller, flow entry information comprising a set of rules and a set of actions, the set of rules configured to match on a layer-2 address assigned to an Internet-of-Things (IoT)-related device or a layer-2 address of an IoT gateway device assigned for the IoT-related device, the set of actions comprising an indication that packets matching the set of rules are to be forwarded from the network switch toward the IoT gateway device or from the network switch toward the wireless access device;
receive, by the network switch, an IoT data packet comprising a layer-2 address field including the layer-2 address assigned to the IoT-related device or the layer-2 address of the IoT gateway device; and
forward the IoT data packet from the network switch toward the wireless access device or toward the IoT gateway device based on the flow entry information.
